(19) United States
(12) Patent Application Publication
(10) Pub. No.: US 2009/0271298 A1
(43) Pub. Date: Oct. 29, 2009

(54) Securitized Commodity Participation Certificates Securitized by Physically Settled Contracts

(75) Inventor: Steven M. Bloom, Springfield, NJ (US)

Correspondence Address: FISH & RICHARDSON PC, P.O. BOX 1022, MINNEAPOLIS, MN, 55440-1022, US

(73) Assignee: THE NASDAQ OMX GROUP, INC.

(21) Appl. No.: 12/108,594

(22) Filed: Apr. 24, 2008

(51) Int. Cl. G06Q 40/00; G06Q 10/00

(52) U.S. Cl. 705/30; 705/35; 705/37

(57) ABSTRACT

Techniques are described for securitizing, administering and trading various derivative shares securitized by derivative, physically-settled instruments on underlying assets that is, physical commodities.

### BACKGROUND

Index futures contracts and Index options provide techniques for investors to invest, trade, or hedge based on the performance of an index. An index futures contract is a futures contract on a financial index such as the S&P 500 index, whereas an Index options contract is an option contract that gives the holder or seller certain rights or obligations with respect to cash amounts based on changes in the underlying index values in relation to the exercise prices on which the option is based. These types of contracts are examples of cash-settled contracts, in which cash is exchanged in settlement of the respective contract rights and obligations.

In contrast, there is another class of futures contracts, physically settled futures contracts, which impose the obligation to make or receive delivery of the underlying physical asset at the settlement date at the final futures settlement value. Physically settled contracts are typically used with commodities such as precious metals (e.g., gold, silver), agricultural products (e.g., pork bellies), energy products (e.g., crude oil), currencies (e.g., euro, yen), and so forth.

While a physically settled futures contract gives the position holder the rights and obligations to make or receive delivery of the underlying asset, an option on a futures contract is itself a physically-settled contract with respect to the underlying futures contract and gives the holder the right to make or receive delivery of the underlying instrument which, in this case, is a futures contract which may itself be physically settled based on an underlying asset.

### SUMMARY

According to an aspect of the present invention, a computer implemented method includes determining in a computer system, a value for a tradable derivative share that tracks performance of a derivative contract that settles with physical delivery of an underlying asset, the derivative contract share backed by a fractional interest in a creation unit that includes the derivative contract and an amount of cash that secures the tradable derivative share.

Embodiments can include one or more of the following.

The derivative contract includes a long position in a physically settled futures contract. The computer implemented includes accessing in the computer system a representation of the creation unit that includes fields that identify the long physically settled futures contract and the defined amount of cash. Accessing in the computer system the representation of the creation unit includes accessing an initial mark price of the physically settled futures contract size multiplier and accessing a current value for the defined amount of cash included in the creation unit. The computer implemented method includes calculating in the computer, the current value for the defined amount of cash by multiplying the market price of the futures contract on a particular date by the futures contract size multiplier. The computer implemented method includes modifying the initial value for the defined amount of cash based on performance of the long physically settled futures contract.

The tradable derivative share comprises a fixed-term tradable long physically settled futures contract and the method includes accessing a record that includes an expiration date of the long physically settled futures contract and accepting delivery of the underlying physical commodity of the long physically settled futures contract on the settlement date, selling the physical commodity in a cash market for the underlying physical commodity and liquidating the tradable derivative shares by distributing cash to accounts of holders of the tradable derivative shares, the cash determined from the cash received from selling the physical commodity and any cash that was held on account. Liquidating the tradable derivative shares includes multiplying the determined value for the tradable derivative shares by a number of tradable derivative shares held by a holder of the tradable derivative shares to generate a total value, subtracting an administration fee from the total value to generate a liquidation value and distributing the liquidation value of cash to the account of the holder of the tradable derivative shares.

According to an aspect of the present invention, a computer implemented method includes recording acceptance of a long physically settled futures contract and cash corresponding to the mark price of the long physically settled futures contract multiplied by a futures contract size multiplier to produce a creation unit and recording in the computer system a plurality of Commodity futures Participation Certificates representing a fractional interest in the creation unit.

Embodiments can include one or more of the following.

The computer implemented method includes recording listing of the Commodity futures Participation Certificates on a securities trading venue. Producing the creation unit includes determining a number of Commodity futures Participation Certificates to issue based on a value of the long physically settled futures contracts. The creation unit includes a plurality of different long open physically settled futures contract positions. The computer implemented method includes disseminating an electronic message to publicly disclose the long physically settled futures contract and a total value of the cash included in the creation unit. The computer implemented method includes recording purchase of an interest bearing instrument with the cash and adding by the computer interest from the interest bearing instrument to the cash.

According to an aspect of the present invention, a computer implemented method includes determining a cash value to give to holders of Commodity futures Participation Certificates that represent an undivided interest in a creation unit of the Commodity futures Participation Certificates by recording acceptance of delivery of physical commodity underlying a long physically settled, futures contract held as a portion of the creation unit along with cash, recording selling of the physical commodity in a cash market for the physical commodity in exchange for cash received and accumulating in the computer the cash received from selling of the physical commodity underlying the long physically settled futures contract with any cash that was part the creation unit.

Embodiments can include one or more of the following.

The computer implemented method includes recording distributing the accumulated cash in exchange for the Commodity futures Participation Certificate shares. The computer implemented method includes determining in the computer a value to provide on each of the Commodity futures Participation Certificates based on the total value of cash divided by the number of Commodity futures Participation Certificates outstanding. The computer implemented method includes determining in the computer a value to provide on each of the Commodity futures Participation Certificates based on the total value of cash minus administrative fees, and the result divided by the number of Commodity futures Participation Certificates outstanding.

According to an aspect of the present invention, a computer program product residing on a computer readable medium for administering tradable derivative shares comprises instructions for causing a computer system to determine a value for a tradable derivative share that tracks performance of a derivative contract that settles with physical delivery of an underlying physical commodity, the derivative contract share backed by a fractional interest in a creation unit that includes the derivative contract and an amount of cash that secures the tradable derivative share.

Embodiments can include one or more of the following.

The derivative contract comprises a long position in a physically settled futures contract. Determining the value of the tradable derivative share comprises instructions to access a data representation stored in the computer system, of the creation unit that includes fields that identify the long physically settled futures contract and the defined amount of cash. The computer program product includes instructions to access an initial mark price of the physically settled futures contract size multiplier and access a current value for the defined amount of cash included in the creation unit. The computer program product includes instructions to calculate the current value for the defined amount of cash by multiplying the market price of the futures contract on a particular date by the futures contract size multiplier. The computer program product includes instructions to modify the initial value for the defined amount of cash based on performance of the long physically settled futures contract.

The tradable derivative share comprises a fixed-term tradable long physically settled futures contract and the computer program product includes instructions to access a record that includes an expiration date of the long physically settled futures contract; and indicate an acceptance of delivery of the physical commodity of the physically settled futures contract on the settlement date when delivery is made, indicate sale of the physical commodity in a cash market for the underlying physical commodity when the sale is made and liquidate the tradable derivative shares by distributing cash to holders of the tradable derivative shares, the cash determined from the cash received from selling the physical commodity and any cash that was held on account. The computer program product includes instructions to multiply the determined value for the tradable derivative shares by a number of tradable derivative shares held by a holder of the tradable derivative shares to generate a total value, subtract an administration fee from the total value to generate a liquidation value and distribute the liquidation value of cash to the holder of the tradable derivative shares.

According to an aspect of the present invention, a computer program product residing on a computer readable medium for administering tradable derivative shares includes instructions for causing a computer system to produce a data representation in a computer system, the data representation representing a creation unit for a tradable derivative share that tracks performance of a derivative contract that settles with physical delivery of an underlying physical commodity the data representation comprising fields that indicate, acceptance of delivery of a long physically settled futures contract, acceptance of delivery of cash corresponding to the mark price of the long physically settled futures contract multiplied by a futures contract size multiplier and store in the computer system, data representations corresponding to a plurality of shares representing a fractional interest in the creation unit.

Embodiments can include one or more of the following.

The computer program product includes instructions to produce an indication that the shares are listed on a securities exchange. The computer program product includes instructions to determine a number of shares to issue based on a value of the long physically settled futures contracts. The data representation of the creation unit includes fields to track a plurality of different long open physically settled futures contract positions that comprise the creation unit. The computer program product includes instructions to disseminate the long physically settled futures contract and a total value of the cash included in the creation unit over an electronic network. The computer program product includes instructions to record in a computer storage medium the purchase an interest bearing instrument with the cash and record in a computer storage medium the addition of interest from the interest bearing instrument to the value of cash stored in the creation unit representation.

According to an aspect of the present invention, a computer program product residing on a computer readable medium for administering tradable derivative shares includes instructions for causing a computer system to determine a cash value to give to holders of Commodity futures Participation Certificates that represent an undivided interest in a creation unit of the Commodity futures Participation Certificates by instructions to record in a data representation of a creation unit corresponding to the Commodity futures Participation Certificates acceptance of delivery of physical commodity underlying a long physically settled, futures contract held as a portion of the creation unit along with cash, record in the data representation of the creation unit, the sale of the physical commodity in a cash market for the physical commodity in exchange for cash received and record an accumulation of the cash received from selling of the physical commodity underlying the long physically settled futures contract with cash value that was part the creation unit.

Embodiments can include one or more of the following.

The computer program product includes instructions to record a distribution of the accumulated cash in exchange for the Commodity futures Participation Certificate shares. The instructions to distribute the cash include instructions to determine a value to provide on each of the Commodity futures Participation Certificates based on the total value of cash divided by the number of Commodity futures Participation Certificates outstanding. The instructions to distribute the cash include instructions to determine a value to provide on each of the Commodity futures Participation Certificates based on the total value of cash minus administrative fees, and the result divided by the number of Commodity futures Participation Certificates outstanding.

According to an aspect of the present invention, a memory storing a data structure for use with an application program that is executed on a computer, the application program for administering tradable derivative shares, the data structure including a data representation of a creation unit, the data representation comprising fields that indicate a long physically settled futures contract, cash corresponding to the mark price of the long physically settled futures contract, a futures contract size multiplier and an entry corresponding to a number of Commodity futures Participation Certificate shares.

Embodiments can include one or more of the following.

The data structure includes a field storing an indication that the Commodity futures Participation Certificate shares are listed on a securities exchange. The data structure includes a field to record the purchase of an interest bearing instrument with the cash and a field to record the addition of interest from the interest bearing instrument to the value of cash stored in the creation unit representation. The data structure includes fields to track a plurality of different long open physically settled Futures Contract positions that comprise the creation unit.

One or more aspects of the invention may include one or more of the following advantages.

The issuer holds a physically settled futures contract and cash in a custody account and issues the tradable, Commodity Participation Certificates (“CP Certificates”) representing a fractional interest in the value of the custody account. Because the futures contract is held by the issuer in a custody account (as opposed to being held by investors), the direct ownership of the futures contract does not change as the tradable CP Certificates are traded. In addition, since the Futures Contracts are not traded at the investor level (e.g., by tradable CP Certificate investors), the tradable CP Certificates can be traded on various venues such as a market, a securities exchange, an electronic commerce network, and so forth.

That is, the arrangement expands distribution channels for commodity exchanges by allowing investors of all types to trade in commodities without the potential of such investors being obliged to make or receive delivery of the underlying physical commodity, because a mechanism is provided for cash-settlement of ordinarily only physically settled instruments. These techniques securitize commodity derivative instruments, allowing them to be traded and held like ordinary securities, e.g., stocks and so forth, in securities accounts.

Other aspects of the invention are described and can be implement as computer implemented, methods, computer program products and systems.

According to additional aspects of the present invention, a computer implemented method, includes determining in a computer system, a value for a tradable commodity participation certificate that tracks increases in a value of a commodity, the tradable commodity participation certificate backed by a fractional interest in a creation unit that includes a long physically settled futures contract for the commodity, and one of a long physically settled put options contract for the commodity and a long physically settled put futures options contract for the commodity, with the long, put index options contract having a strike price that is the same as a mark price of the long index futures contract and each having the same expiration date.

According to additional aspects of the present invention, a computer implemented method includes producing a creation unit by accepting delivery of a long put physically settled options contract and a long physically settled futures contract; and recording a plurality of commodity participation certificates representing a fractional interest in the creation unit.

According to additional aspects of the present invention, a computer implemented method of redeeming commodity participation certificates includes receiving a redemption request from a holder of one or more creation unit size aggregations of commodity participation certificates that are secured by one or more derivative instruments on a physically settled derivative commodity contract and determining by the computer system an amount of cash to deliver along with one or more derivative instruments of the physically settled commodity contract included in the creation unit to the holder of the plurality of commodity participation certificates in exchange for the creation unit size aggregations of commodity participation certificates.

According to additional aspects of the present invention, a computer implemented method of intra-day trading of commodity participation certificates includes accessing, using a computer system, a value of a creation unit based on cash and a value of a physically settled commodity futures contract or an index for the physically settled commodity, trading the commodity participation certificates on a securities trading venue by buyers and sellers determining a price between buyers and sellers for the commodity participation certificates taking into consideration information about the price for the physically settled commodity futures contract or an index for the physically settled commodity.

According to additional aspects of the present invention, a computer implemented method includes determining a value for a commodity participation certificate that provides a multiply enlarged return based on performance of a physically settled commodity, the commodity participation certificate backed by a fractional interest in a plurality of derivative, physically settled commodity instruments and an amount of cash about equal to a strike price for one of the plurality of the derivative, physically settled commodity instruments to secure the commodity participation certificate.

According to additional aspects of the present invention, a computer implemented method includes determining a value for a commodity participation certificate that inversely tracks the value of a commodity, the commodity participation certificate backed by a fractional interest in a derivative physically settled commodity instrument and an amount of cash that secures the commodity participation certificate.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a computer system including interaction with a cash market.

FIG. 1B is a flow chart depicting issuance of Commodity Participation Certificates in physically settled futures contracts.

FIG. 1C is a block diagram depicting a data structure representation of a Commodity Participation Certificate.

FIG. 2 is a block diagram of a creation unit and multiple Commodity Participation Certificates.

FIG. 3 is a block diagram depicting relationships among entities.

FIG. 4 is a chart of the value of a Commodity futures Participation Certificate relative to other investment vehicles.

FIG. 5 is a flow chart of a cash adjustment process for a creation unit.

FIG. 6 is a chart of changes in a mark price and related changes in the cash value of a creation unit.

FIG. 7 is a flow chart of a process for adjusting the cash amount included in a creation unit.

FIG. 8 is a flow chart of a physical settlement process.

FIG. 9 is a flow chart of a settlement process.

FIG. 10 is a flow chart of a redemption process for a creation unit of Commodity futures Participate Certificates.

FIG. 11 is a block diagram depicting a creation unit.

FIG. 12 is a block diagram of a creation unit and multiple Commodity futures Participate Certificates.

FIG. 13 is a block diagram of a creation unit and multiple Commodity futures Participate Certificates.

FIG. 14 is a block diagram of a creation unit and multiple Commodity futures Participate Certificates.

FIG. 15 is a block diagram depicting relationships among entities.

FIGS. 16, 16A and 16B are flow charts of a settlement process.

FIG. 17A is a diagram of changes in the value of a commodity versus time.

FIG. 17B is a diagram of changes in the value of a commodity versus time.

FIG. 18A is a diagram of changes in the value of a commodity versus time.

FIG. 18B is a diagram of changes in the value of a commodity versus time.

FIG. 19 is a flow chart of an options strike price matching process.

FIG. 20 is a block diagram of long call and short put options strike prices.

FIG. 21 is a flow chart of an options strike price matching process.

FIG. 22 is a block diagram of long call and short put options strike prices.

FIG. 23 is a block diagram depicting a creation unit.

FIG. 24 is a block diagram of a creation unit and multiple Commodity option Participate Certificates.

FIG. 25 is a block diagram of a creation unit and multiple Commodity option Participate Certificates.

FIG. 26 is a block diagram of a creation unit and multiple Commodity option Participate Certificates.

FIG. 27A is a diagram of changes in the value of a commodity versus time.

FIG. 27B is a diagram of changes in the value of a commodity versus time.

FIG. 28 is a block diagram of a creation unit and multiple Commodity option Participate Certificates.

FIG. 29A is a diagram of changes in the value of a commodity versus time.

FIG. 29B is a diagram of changes in the value of a commodity versus time.

FIG. 30 is a block diagram of a creation unit and multiple Commodity option Participate Certificates.

FIG. 31 is a block diagram of a computer system.

### DETAILED DESCRIPTION

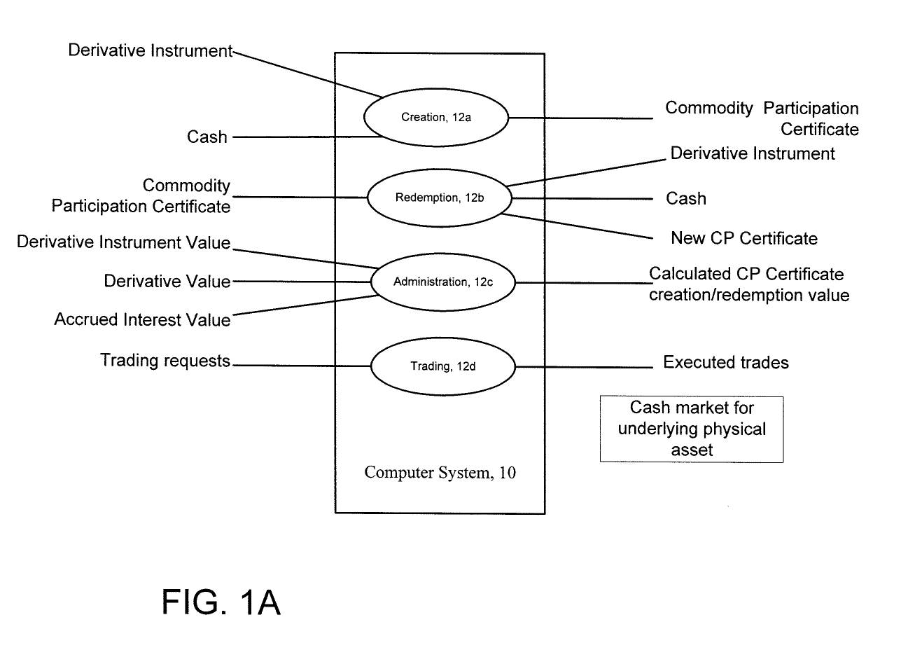

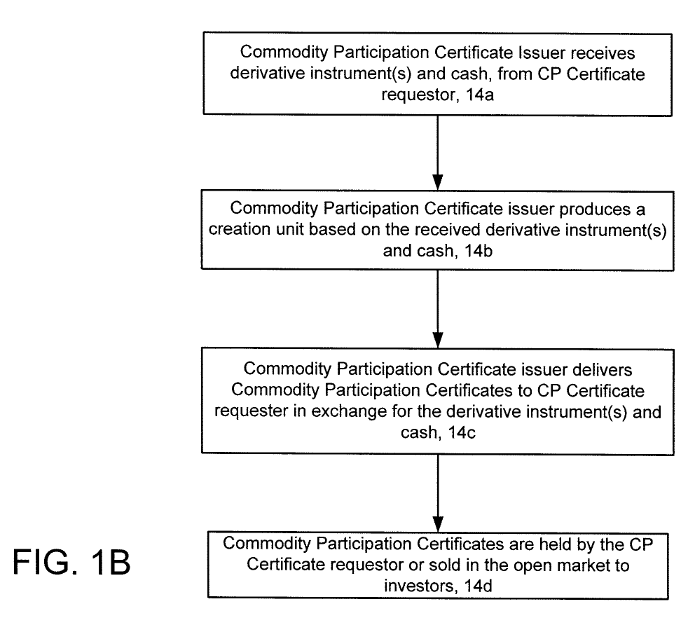

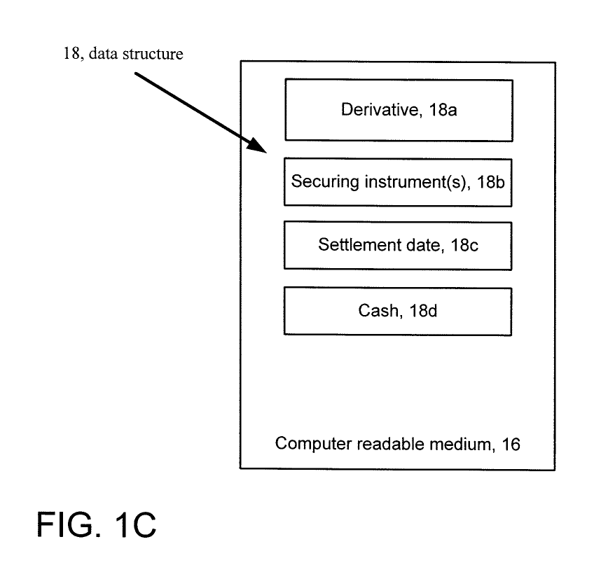

Referring to FIG. 1A, a computer system 10 includes software to assist with creation and issuance 12a, administration 12b, redemption 12c and trading 12d of tradable derivative shares that are here termed “Commodity Participation Certificates.” Although they are discussed herein as being certificates, they can alternatively be considered as participation notes, shares and so forth. The CPC's are structured to trade like securities on a stock exchange but in some embodiments can be considered as derivative instruments and trade like derivatives or futures.

Two types of Commodity Participation Certificates (CPC) are discussed herein—Commodity futures Participation Certificates (CFPC) and Commodity options Participation Certificates (CoPC), with Commodity option Participation Certificates having two general sub-classes—Commodity options Participation Certificates that are based on delivery of a physical commodity and Commodity options Participation Certificates that are based on delivery of a futures contract that is physically settled.

Although a single computer system 10 is shown, typically many such systems can be used and indeed each of the software processes can be performed on different computers, controlled by or managed by different entities that are involved in any of the aspects of the Commodity Participation Certificates. In addition, the computer system 10 or many of such systems would be networked with corresponding computer systems at cash markets for the underlying commodity would be sold with cash proceeds sent to the computer system 10, as will be described below. A cash market is a market in which physical assets, e.g., commodities, such as grain, gold, crude oil, RAM chips, and so forth are bought and sold for cash and delivered immediately. A cash market is also called a “spot market.”

Referring to FIG. 1B, a Commodity Participation Certificate issuer receives (14a) a derivative instrument such as a physically settled futures contract and cash from a Commodity Participation Certificate requester and produces (14b) a creation unit based on the received derivative instrument and cash. The Commodity Participation Certificate issuer, issues (14c) Commodity Participation Certificates that are held by the Commodity Participation Certificate requester or traded by investors (14d) over exchanges, securities markets, electronic communication networks (ECNs) and other trading venues.

The creation unit includes the derivatives contract and an amount of cash to secure the Commodity Participation Certificates. The creation unit is tracks an aspect of performance of a particular, physically settled derivative.

While, in the case of indexes of financial securities that are cash settled, the creation unit tracks the underlying index and corresponds to what is referred to as Index Participation Notes (or Certificates), several examples of which are described in my co-pending patent application “Index Participation Notes Securitized by Futures Contracts” Ser. No. 11/553,521 filed on Oct. 27, 2006 and assigned to the assignee of the present invention.

Non-limiting examples of physically settled derivative contracts include futures contracts that have underlying assets that are typically considered commodities, such as precious metals, e.g., gold, silver, platinum, less-precious metals such as copper, foodstuffs such as orange juice, pork bellies and so forth, or energy-related such as petroleum, gasoline, and so forth, or currencies such as euros or yen and so forth, as well as options on futures contracts not limited to physically settled futures contracts.

The creation unit is held in custody by or on behalf of the Commodity Participation Certificate issuer and includes a combination of cash and the derivative positions that back the Commodity Participation Certificates. The Commodity Participation Certificates represent fractional interests in the creation unit.

Referring to FIG. 1C, the computer system can include a computer readable medium 16 that stores a representation of the Commodity Participation Certificates such as in a data structure, e.g., 18 used with software that assists with creation and issuance, administration, redemption and trading of the Commodity Participation Certificates. Other representations are possible including an unstructured representation, a record in a database, and so forth.

An exemplary data structure 18 used to represent the Commodity Participation Certificates can include a field that identifies the derivative 18a, one or more fields that identify the derivative instrument securing the Commodity Participation Certificates 18b, a field indicating the settlement date of the derivative instrument 18c, and a field storing the value of cash included in the creation unit 18d. As described below, the field storing the value of the cash 18d is updated as the value of the Commodity Participation Certificates changes.

As will be described below, various types of Commodity Participation Certificates are possible. Therefore, fields can be included in the representation of the Commodity Participation Certificates for identifying the types of Certificates and whether the Certificates roll over or are settled out at maturity.

The Commodity Participation Certificate issuer may charge a fee which could be included at issuance, redemption, or during the interim between issuance and redemption of the Commodity futures Participation Certificates 22. If a fee is charged at issuance, the Commodity Participation Certificate issuer adds the fee to the price of the Commodity Participation Certificates. On the other hand, if a fee is charged at redemption, the Commodity Participation Certificate issuer subtracts the fee from the determined total value of the investor's Commodity Participation Certificates on the redemption Certificate.

Creation of Commodity Participation Certificates with Futures Positions

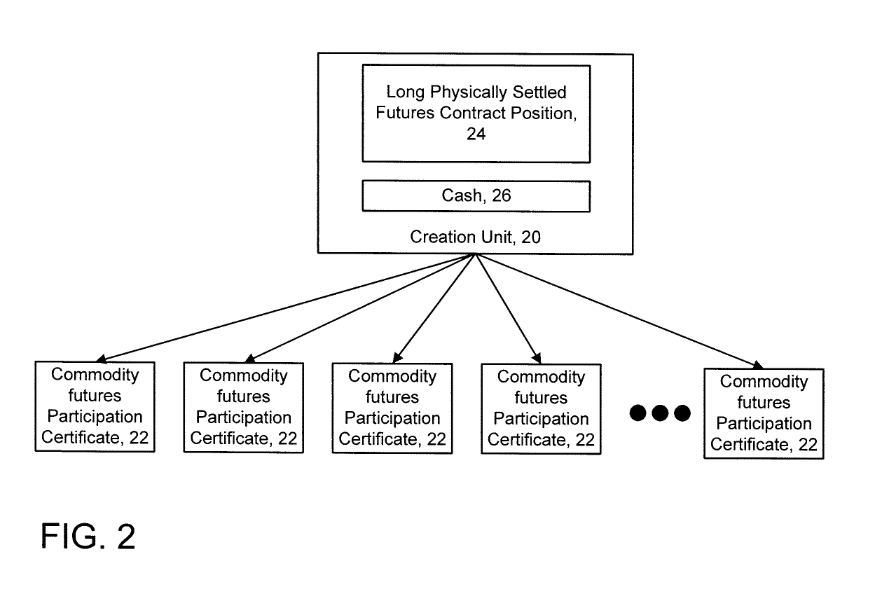

Referring to FIG. 2, one embodiment of the Commodity Participation Certificate is a Commodity futures Participation Certificate (CFPC) 22 that represents a fractional interest in a creation unit 20 that includes both a futures contract 24 and a defined amount of cash 26. Each creation unit 20 is divided into a predefined number of Commodity futures Participation Certificates 22. For example, creation unit 20 can be partitioned into ‘N’ Commodity futures Participation Certificates 22, such that each Commodity futures Participation Certificate 22 represents a 1/N^{th} ownership interest in the physically settled Futures Contract 24 and 1/N^{th} ownership interest in the cash 26 included in the creation unit 20.

The value of the Commodity futures Participation Certificate 22 can be established at some fractional or integer multiple of the value of the physically settled futures contract (e.g., 1/10^{th}, 1/100^{th}, 1/1000^{th}, etc). Other partitions of the creation unit 20 into other amounts of Commodity futures Participation Certificates 22 are possible. The number of Commodity futures Participation Certificates corresponding to a single creation unit can be dependent on the value of the creation unit 20 and can be initially established before the first creation unit is issued. For example, the number of Commodity futures Participation Certificates can be such that the total value of the cash in the creation unit 20 divided by the number of Commodity futures Participation Certificates is between $10 and $10,000.

The futures contract 24 included in the creation unit 20 is a long futures contract position. One exemplary type of Futures Contract is a commodity Futures Contract such as mentioned above.

The amount of cash 26 included in the creation unit 20 varies over time as the value (e.g., the mark price) of the futures contract 24 changes. The computer executing the creation process (or another processing device) computes the initial amount of cash 26 to be placed in the creation unit, tracks changes in the value of the cash 20, and provides up-to-date summaries of the value of the cash 26 included in the creation unit 20.

As physically settled futures contracts are settled by making or accepting delivery of the underlying security or commodity, in order to make the CfPC tradable on a securities market or exchange or ECN, the custodian or custodian's agent or other delivery agent of the CFPC issuer takes delivery of the physical assets underlying the futures contract 24, sells the physical assets in the cash market for that physical asset and then delivers the cash resulting from that sale into the security trading accounts of the CFPC investors.

Thus the computer calculates the value of the cash 26. If the cash 26 is held in an interest bearing account, the computer also tracks the changes in the total value of the cash 26 in the creation unit 20 on any day after creation to reflect principal value (as described above) plus accrued interest.

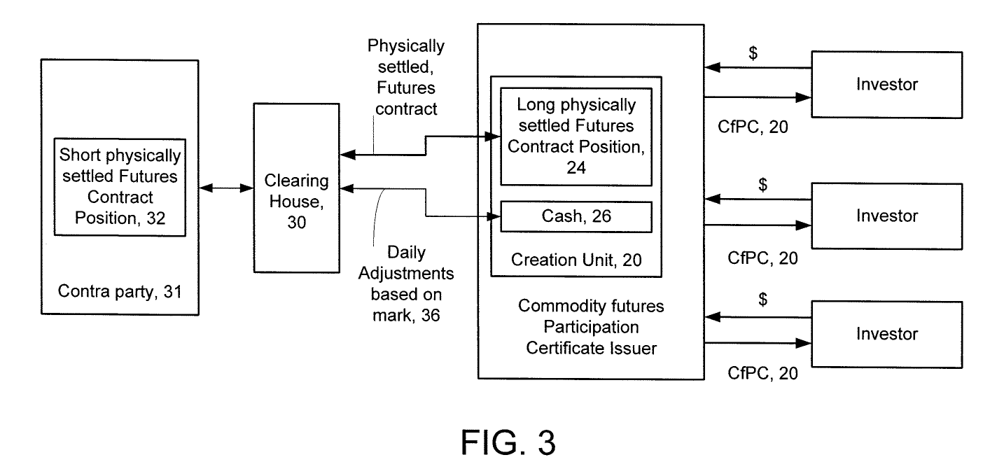

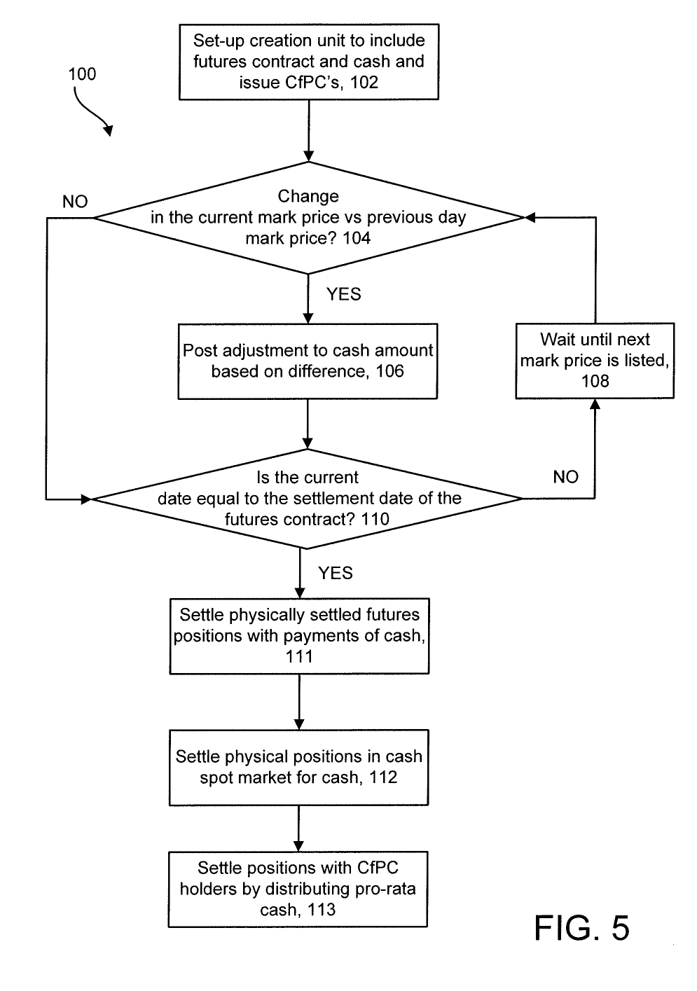

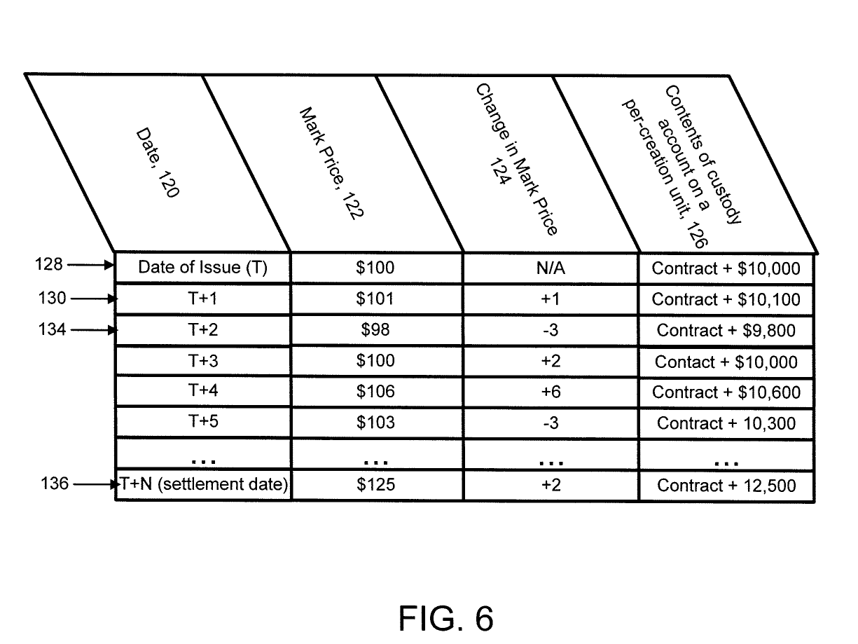

Referring to FIG. 3, in order to facilitate creation of Commodity futures Participation Certificates 22, futures positions are established between a contra-party 31 and the Commodity Participation Certificate-requestor using a clearing house 30. The Commodity futures Participation Certificate requester establishes a long futures contract position 24 while the contra-party 31 establishes a short futures contract position 32. Because the long and short positions are used to determine future credits/debits, no money (other than applicable fees) is exchanged between the clearing house 30 and the Commodity futures Participation Certificate requestor during formation of the long and short futures contract positions 24 and 32. Both the long and short futures contract positions 24 and 32 are established based on a “mark price” for the Futures Contract on the day the contracts 24 and 32 are formed. Money is subsequently exchanged between the contra-party 31 and the Commodity futures Participation Certificate requestor based on differences between the mark price established on the day of issuance of the futures contract and the current mark price for the futures contract (as indicated by arrows 36 and described below in relation to FIGS. 5 and 6). Any changes to the mark price (and therefore to the value of the cash 26 in creation unit 20) are tracked by the computer system such that an accurate value for the cash 26 can be known and reported.

After the futures positions 24 and 32 have been established between the contra-party 31 and the Commodity futures Participation Certificate requester, the Commodity futures Participation Certificate requester requests to generate a creation unit of Commodity futures Participation Certificates with the Commodity futures Participation Certificate issuer who produces a creation unit 20. As described above, the creation unit 20 includes the Futures Contract 24 and a predefined amount of cash 26. The amount of cash 26 included in the creation unit 20 varies based on the market conditions at the time of formation of the creation unit 20. In general, the amount of cash 26 in the creation unit equals the last futures “mark price” for the Futures Contract 24 multiplied by the fractional or integer multiplier of the value of the physically settled futures contract. An example of the contents of an exemplary creation unit 20 is provided below.

In the following example, the Commodity futures Participation Certificates 22 represent a fractional interest in a creation unit 20 based on a less-precious metal (e.g., copper). At the time of establishment of the creation unit, the Commodity futures Participation Certificate has the following market conditions:

Last Futures−Mark−Price=$5

Futures Contract Size=10,000 units of the underlying commodity (e.g., less−precious metal copper)

Based on these market conditions, a creation unit 20 includes, for example, one Futures Contract long position and cash in an amount equal to the $50,000 Futures Contract's last “futures-mark-price” multiplied by the Futures Contract size as it exists on the day of formation of the creation unit 20. In this example, the mark price is $5 and the Futures Contract size (multiplier) for the underlying commodity XYZ is 10,000. Thus, the creation unit 20 could be represented as follows:

One Creation Unit=1 Open Long Futures Contract Position+(Contract's Last Futures Mark Price)*(Futures Contract Size Multiplier)

Thus, based on the exemplary market conditions described above, the creation unit would include:

One Creation Unit=1 Open Long Futures Contract Position+($5)*(10,000)=1 Open Long Futures Contract Position+$50,000

Commodity futures Participation Certificates 22 represent a proportional ownership stake in the creation unit 20. Initially, the Commodity futures Participation Certificates 22 are quoted to investors at a price that is based on the pro-rata cash amount and the net value of the Futures Contract 24 versus its last mark price at the time of quotation of the Commodity futures Participation Certificates 22 after accounting for expenses and fees.

Thus, the market price of the Commodity futures Participation Certificate 22 is initially related to the futures mark to market price of the Futures Contract on the day of formation. For example, based on the exemplary market conditions for (e.g., less-precious metal copper) Commodity futures Participation Certificates described above if each Commodity futures Participation Certificate 22 had a value of 10 times the futures price, the price of the Commodity futures Participation Certificate would be $50 (e.g., the last futures mark price of $5 multiplied by the Futures Contract size multiplier of 10,000 divided by 1000). Thus, there would be 1000 Commodity futures Participation Certificates 22 generated based on the creation unit 20.

After purchasing of the Commodity futures Participation Certificate 22 from the Commodity futures Participation Certificate issuer, the Commodity futures Participation Certificate 22 can be traded using an exchange, a securities market, an electronic communication network (ECN) and other, non, futures trading venues. In order to facilitate open trading of the Commodity futures Participation Certificates 22, the Commodity futures Participation Certificates 22 can be listed and traded like ordinary shares of stock or exchange traded funds (ETFs) on one or more securities exchanges, markets and/or through the matching facilities of one or more electronic communication networks (ECNs).

Secondary market trading of Commodity futures Participation Certificates 22 will be at prices governed by competitive supply and demand forces taking into consideration, among other factors, the values of the futures contract 18, cash 26 and value of the Futures Contract that the Commodity futures Participation Certificates 22 represent. Because the Commodity futures Participation Certificates 22 might be registered and traded in a manner similar to traditional securities on a national securities exchange, the Commodity futures Participation Certificates 22 will be available to be traded and held through any ordinary stock brokerage account and handled by any one of the Registered Representatives in the United States today.

This is in contrast to typical futures trading in which the futures are held in commodity futures trading accounts that are accessible only to accredited investors and particularly investors who may otherwise make or receive physical delivery of the underlying commodity.

This arrangement provides several benefits, including expanding distribution channels for commodity exchanges by allowing investors of all types to have exposure to commodity trading without the potential of such investors being obliged to make or receive delivery of the underlying physical assets in the futures contracts because a mechanism in the investment is provided for a way to cash-settle, which heretofore have been ordinarily only physically settled futures contracts. These techniques securitize commodity futures contacts providing securities can be traded and held like ordinary securities, e.g., stocks and so forth, in securities accounts.

As described above, the Commodity futures Participation Certificate issuer holds the futures contract 24 and cash in a custody account and issues Commodity futures Participation Certificates 22 representing a fractional interest in the value of the custody account. Because the futures contract 24 is held by the Commodity futures Participation Certificate issuer in a custodial account (as opposed to being held by the investors), the ownership of the futures contract 24 does not change as the Commodity futures Participation Certificates 22 are traded. This provides various advantages such as, for example, reducing transaction costs involved with purchasing and trading the Commodity futures Participation Certificates 22. In addition, since there is no trading of the futures contract 24 at the Commodity futures Participation Certificate investor level (e.g., by Commodity futures Participation Certificate investors), the Commodity futures Participation Certificates 22 can be traded on a securities exchange.

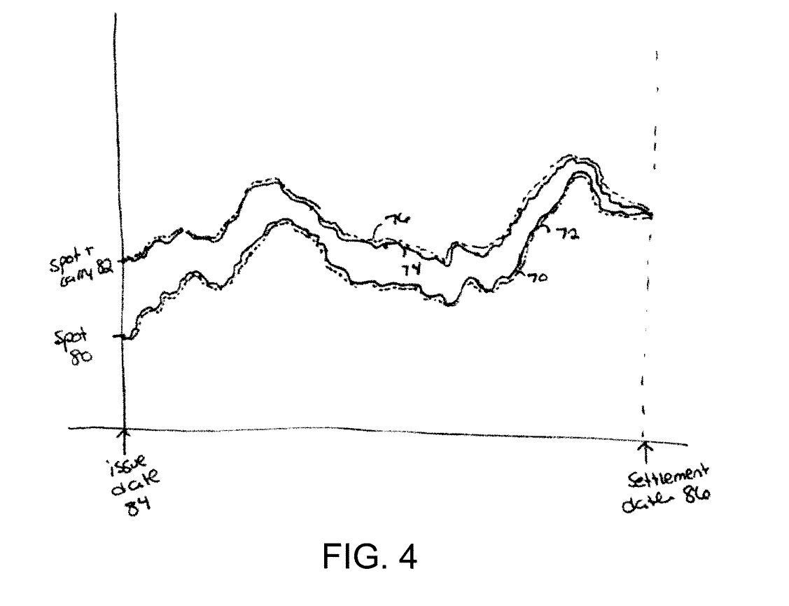

Referring to FIG. 4, the value of the Commodity futures Participation Certificates 22 (represented by line 76) is expected to track the price of the physical asset underlying the futures contracts (represented by line 74). The tracking between the value of the Commodity futures Participation Certificates 22 and the value of the futures contract 24 is based on the inclusion of both the futures contract 24 and the cash 26 in each creation unit 20 for the Commodity futures Participation Certificates 22. Because the cash 26 included in the creation units 20 varies based on the performance of the futures contract 24, the value of the creation unit 20 (and therefore the value of the Commodity futures Participation Certificate 22) will vary based on the performance of the futures contract 24.

On the issue date of the Commodity futures Participation Certificates 22 (indicated by arrow 84), the value of the Futures Contract and the value of the Commodity futures Participation Certificates 22 may in general be different.

The value of the Commodity futures Participation Certificates 22 will track the value of the futures contract 24. However, because the theoretical value of a Futures Contract 24 includes two components, namely “spot value” plus “carry value,” initially, the Futures Contract 24, and therefore the Commodity futures Participation Certificates 22, will closely track movements of the Futures Contract but will diverge in absolute value to the extent of the carry value. The spot value of the asset underlying the Futures Contract is the cash price required to acquire the underlying assets and the carry value of the Futures Contract is the expected cost to hold an ownership interest in the underlying assets until the settlement date 86. The spot value of the asset underlying the Futures Contract will closely track the value of the Futures Contract while the carry value will vary based on interest rates reflecting the purchase price of the underlying asset and remaining time to settlement of the Futures Contract. As the settlement date nears, the carry value for the Futures Contract 24 approaches zero such that the value of the Commodity futures Participation Certificate 22 converges to the value of the underlying Futures Contract as the Futures Contract which itself converges to the underlying value of the commodity.

With this arrangement, the Commodity futures Participation Certificate 22 backed by the long Futures Contract and the cash position is economically equivalent to being long assets underlying the futures contract. More particularly, because the Commodity futures Participation Certificates 22 correspond in value to long positions in both cash 26 and the Futures Contract 18, held in the Commodity futures Participation Certificate issuer's custody account, the value of the Commodity futures Participation Certificates 22 on the settlement date 86 will converge to the value of the underlying contract. Accordingly, as shown in FIG. 4, the value of the Commodity futures Participation Certificates 22 (represented by line 76) and the value of the Futures Contract (represented by line 70) converge to the same price 78 on the settlement date 86. Thus, the position claimed by the Commodity futures Participation Certificates 22 (i.e., a long Futures Contract plus cash) has the same economic value as owning the underlying assets on the settlement date 86.

Referring to FIG. 5, a process 100 for adjusting the amount of cash 26 in the creation unit 20 based on the performance of the Futures Contract 24 is shown. As described above, the intrinsic day-to-day value of the Commodity futures Participation Certificate 22 will vary based on the price performance of the Futures Contract 24.

The creation unit 20 is initially established to include the Futures Contract 24 and an amount of cash 26. A computer system stores the contents of the creation unit 20, e.g., the Futures Contract 24 and the amount of cash 26 and records the fractional interest represented by each of the Commodity futures Participation Certificates 22. On the date of formation of the Futures Contract 24 an initial mark price is established 102. Since the mark price is used subsequently to determine adjustments in the cash 26, the computer stores the mark price.

The initial mark price for the Futures Contract is subsequently updated at predetermined time intervals (e.g., the close of each daily trading session). After the mark price has been updated, the computer stores the new mark price and compares 104 the new mark price to the previous mark price to determine if there has been a change. If there is a difference between the current and previous mark prices, the accounts of the long position holder and short position holder of the futures contracts are adjusted 106 based on the difference.

Because the Commodity futures Participation Certificate issuer holds a long Futures Contract 24, if the mark price increases, the difference between the two mark prices (e.g., a positive value) will be credited to the Commodity futures Participation Certificate issuer's account at the clearing house 30 and the difference between the two mark prices will be debited from the account of the contra-party 31 that holds the short Futures Contract position. In contrast, if the mark price decreases, the difference between the two mark prices will be debited from the Commodity futures Participation Certificate issuer's account and the difference between the two mark prices will be credited to the account of the contra-party 31.

The intrinsic value of the Commodity futures Participation Certificate 22 will increase when the mark price for the Futures Contract 24 rises and will decrease when the mark price for the Futures Contract 24 falls. All changes in the value of creation unit 20 (e.g., changes in the value of the cash 20) are tracked by the computer system.

After the accounts of the Commodity futures Participation Certificate issuer and the contra-party 31 have been adjusted or if no adjustment is needed, the computer system determines 110 if the current date is equal to the settlement date for the Futures Contract 24. If the date is not the settlement date, the determination of change in mark price and adjustment of the accounts is repeated. If the date is the settlement date, the issuer, custodian, or agent of the issuer or custodian facilitates distribution of cash proceeds upon maturity of CP Certificates by buying 111 the underlying commodity for cash from the custody account paid to the short futures position holder in exchange for receiving delivery of the asset underlying the physically settled futures contract to settle the physically settled futures contract obligation. The issuer, custodian, or agent of the issuer or custodian, sells 112 in the cash market the asset underlying the physically settled futures contract which was received to settle the physically settled futures contract obligation, and distributes 113 the cash proceeds, net of expenses, pro rata to CfPC holders.

Referring to FIG. 6, exemplary adjustments to the contents of a creation unit 20 (represented in column 126) based on the changes in the mark price (shown in columns 122 and 124) for the underlying Futures Contract 24 are shown. The illustrative example assumes a physically settled futures contract, which constitutes 100 units of the underlying physical asset. On the date of issue of the Futures Contract 18, an initial mark price is established. As shown in row 128, on the date of issue (T), the mark price 122 for the Futures Contract is $100. In this example, the Futures Contract multiplier for the Futures Contract future is assumed to be one-hundred for ease of explanation. As such, the contents of the creation unit 20 upon establishment include the Futures Contract 24 and the defined cash 26 amount that equals the Futures Contract's mark price multiplied by the Futures Contract size multiplier. As shown in row 130, on the day following the date of issue (T+1), the mark price 122 for the Futures Contract has increased to $101. Thus, the change in the mark price 124 is +1 and the amount of cash in the creation unit 20 increases by $100 to $10,100. As shown in row 132, on the following day (T+2), the mark price for the Futures Contract has decreased to $98. Thus, the change in the mark price 124 is −3 and the amount of cash in the creation unit 20 decreases by $300 to $9,800. Such adjustments continue until the date of settlement of the Futures Contract 18.

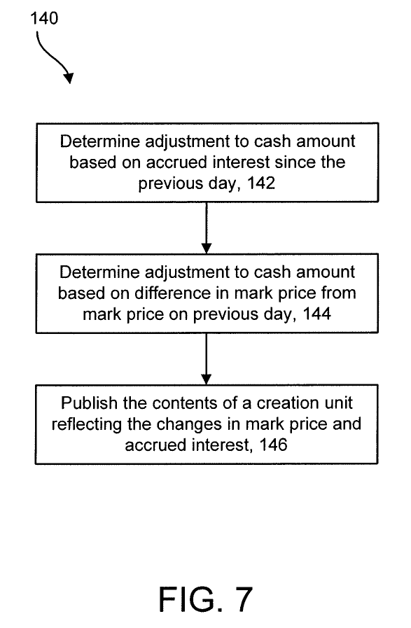

Referring now to FIG. 7, the contents of the creation unit, and thus the value of each Commodity Participation Certificate, are adjusted based on accrued interest on the cash 26 held in the creation unit 20. For example, the cash 26 included in the creation unit 20 could be held in treasurer's Certificates or an interest bearing account or other type of interest bearing instrument including the clearing member's interest bearing account at the clearing house. The interest earned is credited to the value of the creation unit 20. If the cash 26 is held in an interest bearing account, the value of the cash 26 increases over time. In order to accurately assess the value of the Commodity futures Participation Certificates 22, a computer maintains an accurate representation of the value of the Futures Contract 24 and the value of the cash 26 (including both adjustments based on the performance of the futures contract and based on the accrued interest).

A computer implemented process 140 for reporting the current value of a creation unit 20 includes using a computer system to determine 142 adjustments to the cash 26 based on the accrued interest since the previous reporting period, for example, the accrued interest since the previous day. The computer system also determines 144 adjustments to the cash 26 based on differences between the current mark price and the previous mark price. After determining both the adjustment to the cash 26 based on the performance and the interest, the computer system provides the necessary information for the Commodity futures Participation Certificate issuer to publish 146 the contents of the creation unit 20 to reflect the current value of the cash 26 included in the creation unit 20.

The value of the creation unit 20 on any given day is primarily the value of the cash 26 included in the creation unit. The relative proportion of value of the Futures Contract 24 to the cash 26 included in the creation unit 20 is low. The majority of the value of the creation unit 20 is cash 26 because the Futures Contract 24 simply adjusts the total amount of cash 26 by incremental amounts on a day-to-day basis. Thus, the value of the Futures Contract 24 in the creation unit 20 is effectively converted to a cash amount (e.g., the adjustment based on the mark price) each day. The value of the creation unit 20 and, thus, the Commodity futures Participation Certificates 22, is primarily based on the cash 26 included in the creation unit 20. As a financial claim on cash may be regarded as a security notwithstanding its commodity basis in futures, the Commodity futures Participation Certificates 22 may be regarded as securities that can be traded on a securities market.

### Redemption/Settlement of Commodity Participation Certificates

As described above, the Commodity futures Participation Certificates 22 are based on a creation unit 20 that includes a Futures Contract 24 and a defined amount of cash 20. The Futures Contract 24 has a settlement date that is set and known at the date of issuance of the Futures Contract 18. Because the Commodity futures Participation Certificates 22 are based on the Futures Contract 18, in some embodiments, the Commodity futures Participation Certificates 22 also have a fixed term.

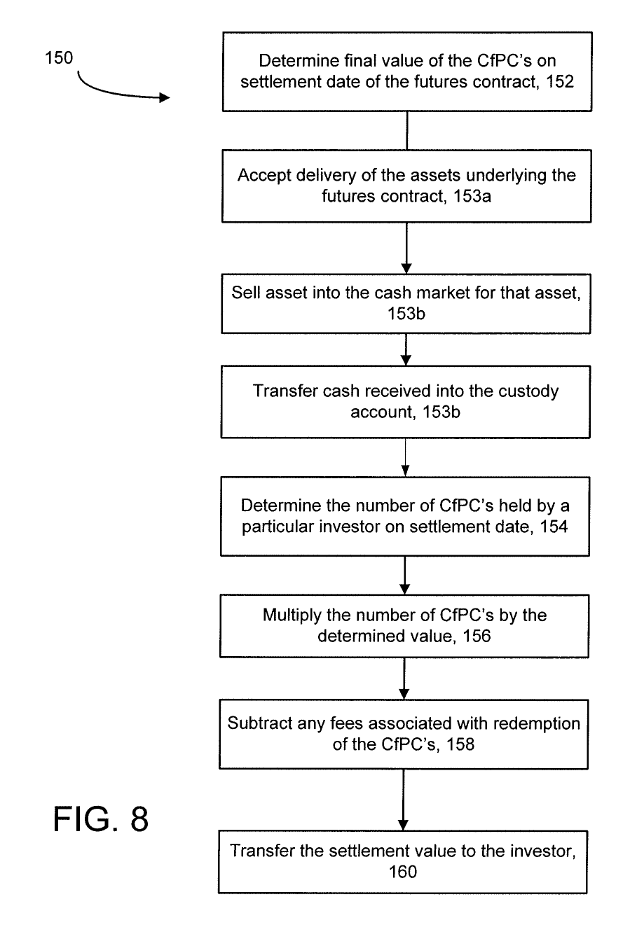

Referring to FIG. 8, in one embodiment, the Commodity futures Participation Certificates 22 have a fixed term, e.g., a settlement/liquidation date that coincides with a settlement/liquidation date underlying the futures contract 18.

Settlement 150 of fixed term Commodity futures Participation Certificates 22 includes determining 152, typically by the Commodity futures Participation Certificate issuer, the final value for the Commodity futures Participation Certificates 22 on or after the settlement of the Futures Contract 24 and converting the futures contracts into cash.

Unlike cash settled instruments, futures contracts on commodities are ordinarily physically settled. Thus, in order to convert the futures contract into cash, the Commodity futures Participation Certificate issuer or its custody bank or other agent, accepts 153a delivery of the assets underlying the futures contract, which in turn the Commodity futures Participation Certificate issuer sells 153b into the cash market for that asset. The cash received from the sale of the physical assets are transferred 153c into the custody account.

A computer system calculates the final value of the Commodity futures Participation Certificates 22 based on the cash price received for the assets underlying the open long futures contracts 24 on the settlement date and any interest net of expenses accrued on the cash 26 in the creation unit 20. As such, the final value calculated by the computer system reflects the cash redemption of the futures contract 18c and reflects the interest net of expenses gained on the cash 20.

The Commodity futures Participation Certificate issuer determines 154 the number of Commodity futures Participation Certificates 22 held by a particular investor on the settlement date. The Commodity futures Participation Certificate issuer uses the computer system to determine 156 the value of the Commodity futures Participation Certificates 22 by multiplying the number of Commodity futures Participation Certificates 22 held by each investor by the determined value for the Commodity futures Participation Certificates 22.

The Commodity futures Participation Certificate issuer may charge an additional fee for redemption of the Commodity futures Participation Certificates 22. If an additional fee is charged for redemption, the computer system subtracts 158 the fee from the determined total value of the investor's Commodity futures Participation Certificates. The Commodity futures Participation Certificate issuer transfers 160 the value of the investor's Commodity futures Participation Certificates less any fees to the investor.

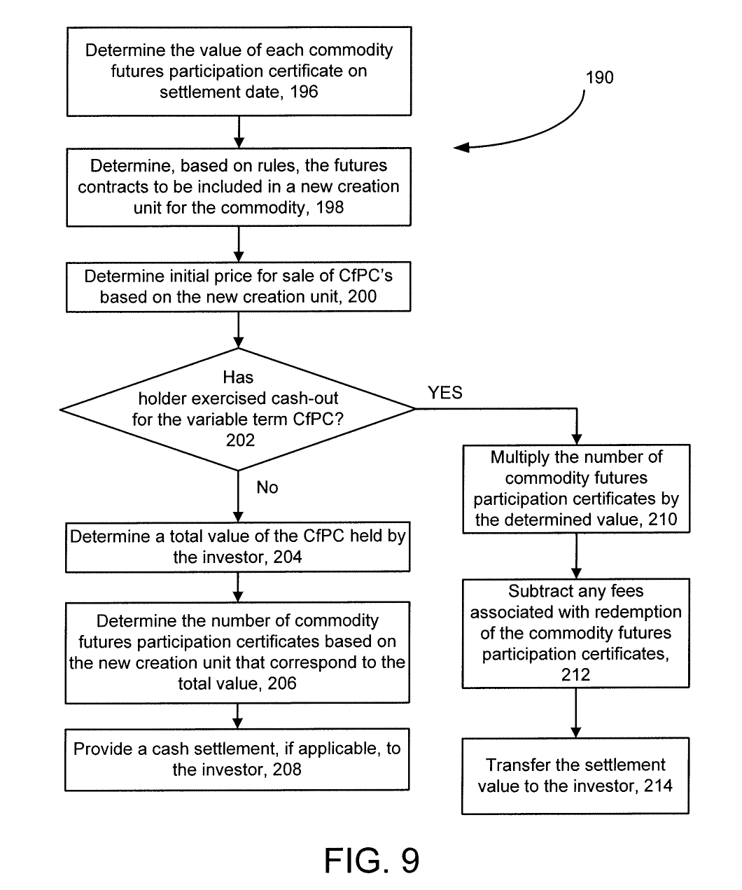

Referring now to FIG. 9, a process 190 for settlement of variable term Commodity futures Participation Certificates 22 is shown. On the settlement date for the commodity futures contract 18, the Commodity futures Participation Certificate issuer uses a computer to determine 196 the value of each Commodity futures Participation Certificate 22. The Commodity futures Participation Certificate issuer determines 198, based on rules, a new, one or more future-dated, physically settled futures contracts to include in a new creation unit based on the commodity and goes into the market to secure those contracts following non-discretionary execution rules.

For example, the initial futures contracts included in the creation unit 20 could be pork belly futures contracts with a settlement date of December 2008. On the settlement date, the pork belly futures contract is settled and a new futures contract with a settlement date 1 year later (e.g., a 2009 pork bellies futures contract) is purchased.

After the futures contract for the new creation unit is determined, the Commodity futures Participation Certificate issuer uses a computer to calculate 200 the initial price for the Commodity futures Participation Certificates based on the creation unit 20 that includes the new commodity futures contract. This price could be greater than, equal to, or less than the value of the Commodity futures Participation Certificates on the settlement date. In accounting for fair value in a roll-over election, a Rollover Cash Contribution or Rollover Cash Credit may apply.

For Commodity futures Participation Certificates 22 having a variable term, the holder of the Commodity futures Participation Certificate can decide whether to hold the Commodity futures Participation Certificate (and thus receive interest in the new creation unit) or to liquidate the Commodity futures Participation Certificate for cash. The Commodity futures Participation Certificate issuer determines 202 if the certificate holder has exercised the cash-out option for the Commodity futures Participation Certificate 22.

If the Commodity futures Participation Certificate holder has exercised the cash out option or the Commodity futures Participation Certificates 22 are fixed term, the Commodity futures Participation Certificate issuer uses a computer to calculate the payment due to the holder of the Commodity futures Participation Certificates 22. The computer multiplies 21 0 the number of Commodity futures Participation Certificates 22 by the determined value for the Commodity futures Participation Certificates and subtracts 212 any fees associated with redemption of the Commodity futures Participation Certificates 22. The Commodity futures Participation Certificate issuer transfers 214 the calculated settlement value to the Commodity futures Participation Certificate holder in exchange for or otherwise retiring the Commodity futures Participation Certificates 22.

If the Commodity futures Participation Certificate holder has not exercised the cash-out option and the Commodity futures Participation Certificates are all variable term, the Commodity futures Participation Certificate issuer uses a computer system to calculate 204 a total value of the Commodity futures Participation Certificates 22 held by the investor. The computer system determines 206 the number of the new Commodity futures Participation Certificates that correspond to the total value of the old Commodity futures Participation Certificates based on the issue price for Commodity futures Participation Certificates 22 based on the new creation unit and the Commodity futures Participation Certificate issuer issues the new Commodity futures Participation Certificates 22 to the certificate holder.

The computer system also determines if a cash settlement is necessary to account for differences in the value of the Commodity futures Participation Certificates originally held by the investor and the newly issued Commodity futures Participation Certificates. If such a settlement is due, the Commodity futures Participation Certificate issuer provides 208 the cash settlement, e.g., for an odd lot amount if applicable, to the Commodity futures Participation Certificate holder. As previously mentioned, in accounting for fair value in the roll-over election, a Rollover Cash Contribution or Rollover Cash Credit may apply.

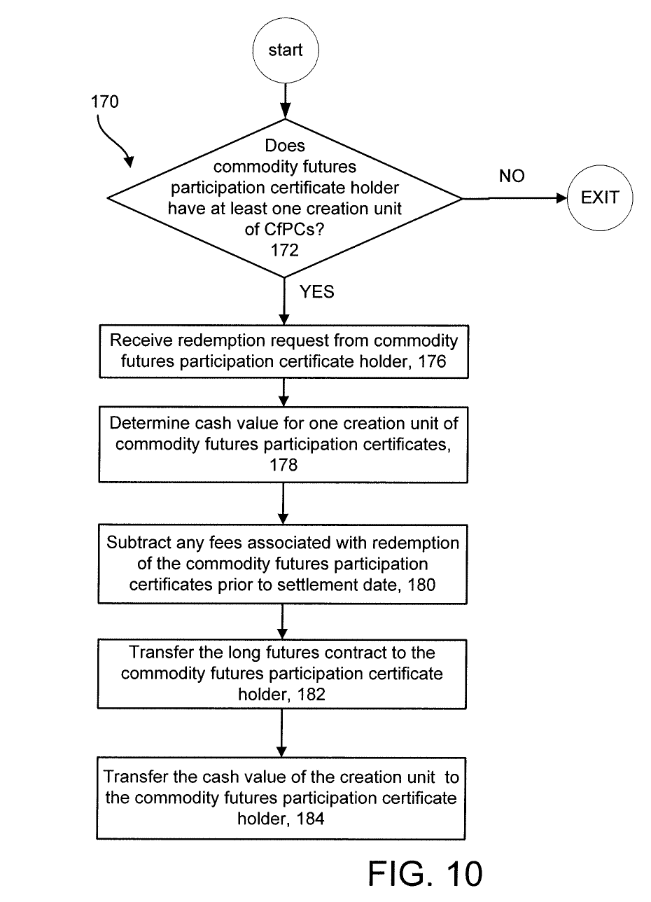

Referring to FIG. 10, in some embodiments, a Commodity futures Participation Certificate holder may be able to redeem Commodity futures Participation Certificate 22 from the Commodity futures Participation Certificate issuer prior to the settlement date based on a process 170 for redeeming creation unit-size aggregations of Commodity futures Participation Certificate 22 by request of a Commodity futures Participation Certificate holder. If the Commodity futures Participation Certificate issuer allows redemption of creation unit-size aggregations of Commodity futures Participation Certificate 22, the Commodity futures Participation Certificate issuer determines 122 if the Commodity futures Participation Certificate owns a creation unit-size aggregation of Commodity futures Participation Certificates.

If the Commodity futures Participation Certificate holder does not own a creation unit-size aggregation of Commodity futures Participation Certificate, the Commodity futures Participation Certificate 22 may be traded on an exchange, market or other trading venue. When the Commodity futures Participation Certificate holder owns less than a creation unit-size aggregation of Commodity futures Participation Certificates, the Commodity futures Participation Certificate holder cannot redeem the Commodity futures Participate Certificates 22 prior to the settlement date of the futures contract 18.

If the Commodity futures Participate Certificates holder does own a creation unit-size aggregation of Commodity futures Participation Certificates, the Commodity futures Participation Certificate issuer receives 176 a redemption request from the Commodity futures Participation Certificate holder. The Commodity futures Participation Certificate issuer uses a computer system to calculate 178 the current pro-rata cash value for a creation unit of Commodity futures Participation Certificates. The cash value includes the total value of the cash 26 in the creation unit 20.

The Commodity futures Participation Certificate issuer may charge a fee for redemption of the Commodity futures Participation Certificate 22 prior to the settlement date. If such a fee is charged, the computer system subtracts 180 the fee associated with the redemption from the total cash value of the creation unit. Because the settlement date of the futures contract has not yet arrived, the Commodity futures Participation Certificate issuer transfers 182 the futures contract 24 in the creation unit 20 and transfers 184 the cash value less any fees to the Commodity futures Participation Certificate holder in exchange for the Commodity futures Participation Certificates 22.

### Creation Unit Including Multiple Futures Contracts

While the creation unit 20 in the embodiments described above has been described as including a single physically settled futures contract 24 and a defined amount of cash 20, other arrangements are possible. For example, the creation unit 20 could include a blend of multiple, different physically settled futures contracts.

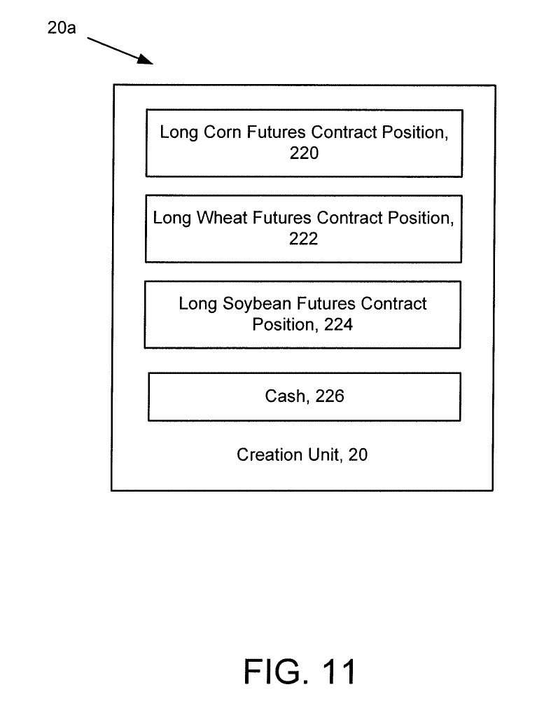

Referring to FIG. 11, in one particular example (representing a data structure 20a), the creation unit 20 includes weighted amounts of each of corn futures, wheat futures, and soybean futures. As shown in FIG. 11, the creation unit 20 includes one long corn futures contract position 220, one long wheat futures contract position 222, and one long soybean futures contract position 224. The creation unit also includes a predetermined amount of cash 226. Upon formation of the creation unit 20, the value of the cash 226 would be a sum of the initial mark price for the long corn futures contract 220, the initial mark price for long wheat futures contract 222, and the initial mark price for long soybean futures contract 224. Upon settlement, the value of the creation unit 20 will converge to the sum of the value of the cash prices for the corn, wheat and soybeans, after accounting for multipliers in the creation unit and accrued interest on the cash held in the creation unit.

### Magnified Commodity Futures Participation Certificate

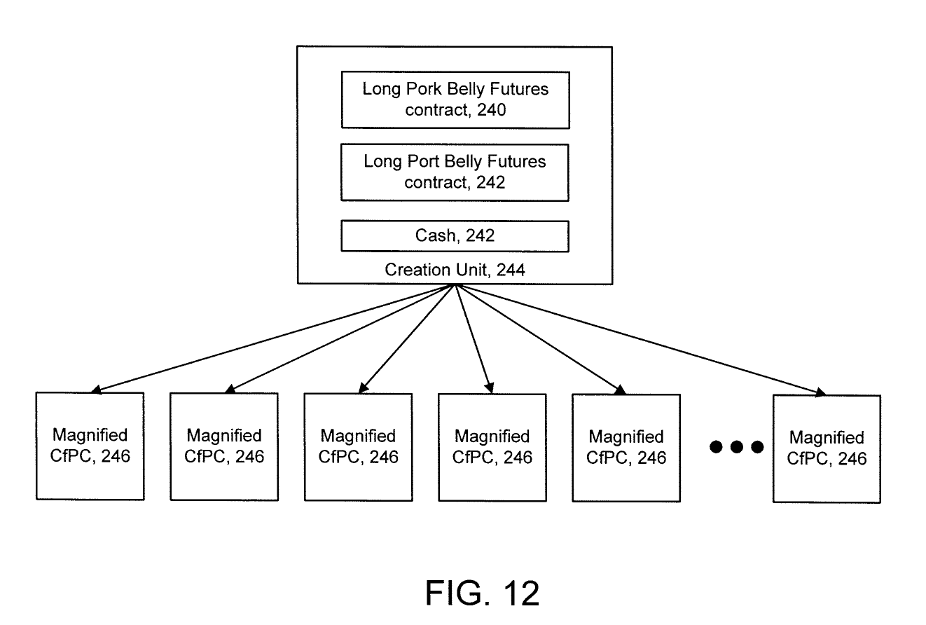

Referring to FIG. 12, an alternative embodiment of a creation unit 244 includes multiple futures contracts (e.g., long pork belly futures contract 240 and long pork belly futures contract 242). The amount of cash is equal to the mark price of a single futures contract. For example, if long pork belly futures contracts 240 and 242 each have a mark price of $1500, upon generation of the creation unit 244 the amount of cash 242 would be $1500. Including multiple futures contracts 240 and 242 in the creation unit 244 increases the leverage of the Commodity futures Participation Certificate 246 by magnifying the position taken by the long pork belly futures contract. For example, with the single futures contract embodiment described above, the resulting creation unit is based on a single futures contract and the mark price of the single contract and when the value of the commodity increases by 1% the value of the Commodity futures Participation Certificate 22 increases by 1%. Whereas, when the creation unit 244 includes two long pork belly futures contracts 240 and 242 and the cash 242 in the creation unit 244 is equal to the mark price of one of the two pork belly futures contracts, when the value of the pork belly futures increases by 1% the value of the Commodity futures Participation Certificate 246 increases by about 2% (correspondingly when the value falls by 1% for the futures contract the value falls by about 2% for the Commodity futures Participation Certificate 246). Thus, the number of long futures contracts included in the creation unit 244 serves as a multiplier to the gains/losses incurred by the magnified Commodity futures Participation Certificates 246.

The number of futures contracts in the creation unit 244 for the magnified Commodity futures Participation Certificates 246 can vary. For example, the Commodity futures Participation Certificate issuer could issue magnified Commodity futures Participation Certificates 246 with between two and ten futures contracts included in the creation unit 244. If the creation unit 244 includes ten long futures contracts, a one percent increase in the value of the futures contract would generate a corresponding ten percent increase (approximately) in the value of the magnified Commodity futures Participation Certificate 246.

### Creation and Redemption Arbitrage

In some embodiments, issuance and subsequent trading of the Commodity futures Participation Certificates 22 may result in the Commodity futures Participation Certificates (e.g., Commodity futures Participation Certificates 22) trading at a slight premium or discount to the futures contracts. When the Commodity futures Participation Certificates 22 are trading at a slight premium or discount, an arbitrageur would use the situation to arbitrage based on the premium or discount.

If the Commodity futures Participation Certificates 22 are trading at a premium to the futures contracts 18, the arbitrageur can make money using a creation arbitrage scenario. For example, if Commodity futures Participation Certificates for a particular settlement date are trading at a premium to the futures with the same settlement date an arbitrage scenario exists. The arbitrageur sells one creation unit worth of Commodity futures Participation Certificates of that settlement date, at the premium price on a stock exchange and buys one futures contract at the discount price to lock in the price differential. The arbitrageur requests a creation of one creation unit of newly-issued Commodity futures Participation Certificates of that date, from the Commodity futures Participation Certificate issuer and delivers out (via clearing house transfer) an open futures position plus cash to the Commodity futures Participation Certificate issuer. The arbitrageur receives one creation unit of Commodity futures Participation Certificates of that date from the Commodity futures Participation Certificate issuer to cover the sale on the stock exchange on T+3 settlement and also receives more than enough proceeds from the sale of the Commodity futures Participation Certificates on T+3 settlement to cover the cash delivery to the Commodity futures Participation Certificate issuer for the creation with the excess cash proceeds corresponding to the arbitrages profit from the creation transaction. Thus, as shown above, if the Commodity futures Participation Certificates are trading at a premium to the futures contracts, the arbitrageur can make money off the difference in price.

Conversely, if the Commodity futures Participation Certificates are trading at a discount to the futures contracts, the arbitrageur can make money using a redemption arbitrage scenario. For example, if Commodity futures Participation Certificates with a December 2008 settlement date are trading at a discount to the futures with the same settlement date, an arbitrage scenario exists. The arbitrageur buys one creation unit of the Commodity futures Participation Certificates for a particular settlement date, at the discount price on the stock exchange, and sells one futures contract of that same settlement date at the premium price to lock in differential. The arbitrageur requests redemption of one creation unit of the Commodity futures Participation Certificates from Commodity futures Participation Certificate issuer and receives in (via a clearing house transfer) an open long futures position plus more than enough cash from the Commodity futures Participation Certificate issuer to cover the purchase of the Commodity futures Participation Certificates, with the excess cash corresponding to the arbitrage profit from the redemption transaction. The arbitrager delivers one creation unit of Commodity futures Participation Certificates of that particular settlement date to the Commodity futures Participation Certificate issuer to effect the in-kind redemption of the Commodity futures Participation Certificates.

### Creation Unit Including Short Futures Contracts (Bear Commodity Futures Participate Certificates)

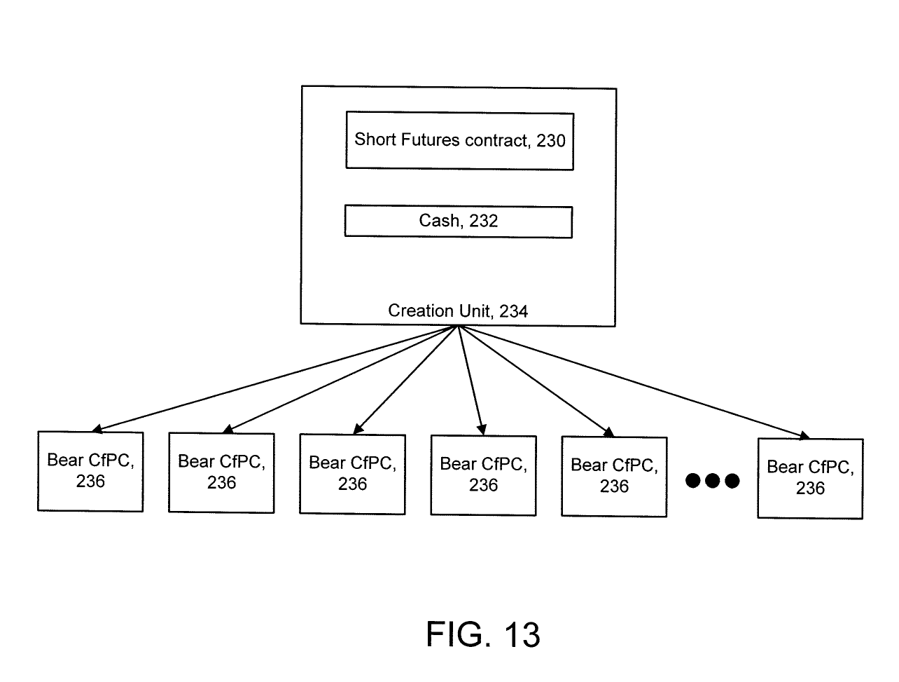

Referring to FIG. 13, while in the examples described above the creation unit (e.g., creation unit 20 or creation unit 244) included long futures contract(s), in some embodiments a creation unit 234 can include a short futures contract 230 position. In order to form the creation unit 234, the Commodity futures Participation Certificate issuer accepts a short futures contract plus cash from a Commodity futures Participation Certificate creator in exchange for the issuance of Bear Commodity futures Participation Certificates. Daily mark-to-market cash credits are posted to the futures clearing margin account on a short futures position corresponding to futures price decreases below the original futures mark price. Conversely, daily mark-to-market cash debits are posted to the futures clearing margin account on a short futures position corresponding to futures price increases above the original futures mark price. Such Commodity futures Participation Certificates issued based on a creation unit 234, (a short futures contract) are referred to herein as “bear” Commodity futures Participation Certificates 236 because their performance will have an inverse relationship to the performance of the value of the underlying commodity. Thus, if the value of the commodity decreases below its initial mark price, the value of the bear Commodity futures Participation Certificates 236 increases because the short futures positions are credited with cash, as the futures mark goes down; and if the value of the commodity increases, the value of the bear Commodity futures Participation Certificates 236 decreases because short futures positions are debited as the futures mark goes up.

The creation unit 234 also includes a pre-defined amount of cash 232. Because the price of the futures contract 230 and the cash 232 converge to the cash value of the commodity on the final settlement date of the futures contract 230, the cash value 232 included in the creation unit 234 upon generation of the bear Commodity futures Participation Certificates 236 can be calculated by a computer system to account for the inverse relation between the cash value and the Commodity futures Participation Certificate value.

### Balanced-Asset Futures Based Commodity Futures Participate Certificates

In some embodiments, investment instruments other than futures contracts can be included in a creation unit and used to generate Commodity futures Participation Certificates. For example, a creation unit could blend futures contracts for diversified asset exposure in pre-determined, weighted amounts between different classes of commodities, e.g., foodstuffs, precious metals, energy and so forth, provided such futures contracts are physically settled in the manner previously described.

### Options-Based Commodity Participation Certificates

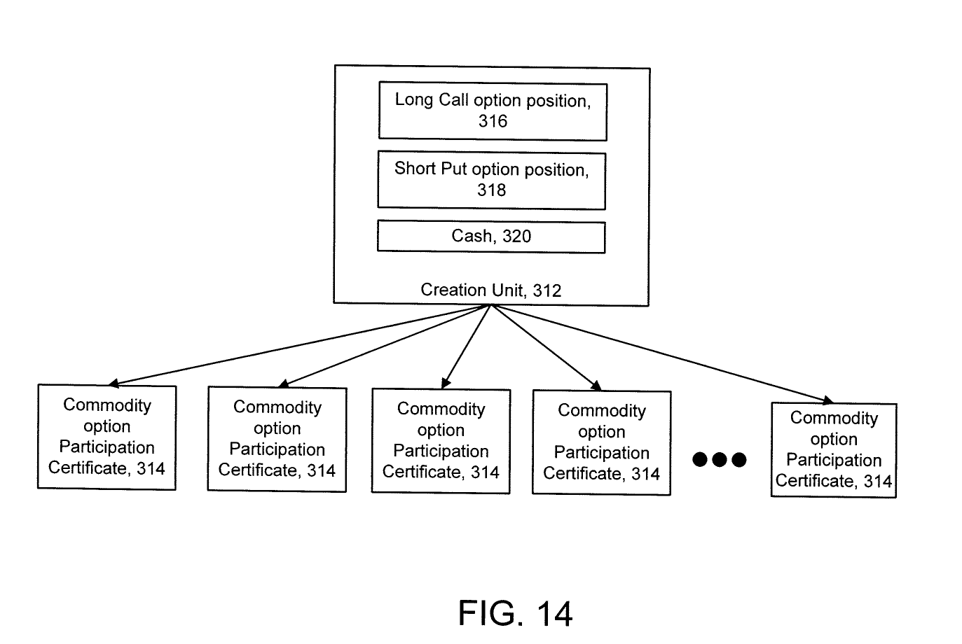

Referring to FIG. 14, an alternative embodiment of Commodity Participation Certificates 314 has a Commodity Participate Certificate issuer issuing Commodity option Participation Certificates 314 that are backed by call and put option positions on a particular, physically settled commodity option. The Commodity option Participation Certificates 314 are tradable shares that are backed by a fractional interest in a long call option position 316, a short put option position 318, and a defined amount of cash 320 all of which are included in a creation unit 312. The options, both the call and the put options, are options that are physically settled, either by: delivery of or acceptance of delivery of a physical commodity; or are options on delivery of or acceptance of delivery of physically settled futures contracts on a commodity, which in this situation can include futures contracts on financial instruments (e.g., such as foreign currencies or U.S. Treasury securities).

Each creation unit 312 is divided into multiple Commodity option Participation Certificates 314. For example, creation unit 312 can be partitioned into 100 Commodity option Participation Certificates 314, such that each Commodity option Participation Certificate 314 represents a 1/100th ownership interest in the long call and short put options positions 316 and 318 and a 1/100th ownership interest in the cash 320 included in the creation unit 312. Other partitions of the creation unit 312 into other amounts of Commodity option Participation Certificates 314 are possible. In some embodiments, each creation unit is divided into from about 100 to about 10,000 Commodity option Participation Certificates 314.

In one embodiment, options contracts such as the long call option position 316 and the short put option position 318 are call/put options based on a commodity such as “pork bellies,” which may be European exercised (i.e., exercised on expiration only) or American exercised (i.e., exercisable on or before the expiration date). In another, the options contracts such as the long call option position 316 and the short put option position 318 are call/put options on a futures contract that is physically settled such as by delivery of or acceptance of delivery of a commodity such as “pork bellies,” which may be European exercised (i.e., exercised on expiration only) or American exercised (i.e., exercisable on or before the expiration date). That is in the first embodiment the options are on the underlying physical commodity, whereas in the second embodiment the options are on futures contracts on the underlying physical commodity.

The long, call option position 316 included in the creation unit 312 gives the holder of the position (e.g., the CoPC issuer 310) the right to obtain delivery of the physical asset at the strike price on the option expiration date (commodity, e.g., pork bellies or a futures contract on commodity, e.g., pork bellies). Thus, if the value of the commodity increases in value above the strike price, the long call option position increases in value.

On the other hand, the short, put option position 318 gives the holder of the short position the obligation to purchase the physical asset at the strike price on the option expiration date. Thus, if the commodity decreases in value below the strike price, the short put option position decreases in value because fulfillment of its obligation entails buying the commodity at the strike price which is relatively higher than the market value. Conversely, if the commodity increases in value, the short put option position increases in value as in the case of the long call option position.

A computer system calculates the amount of cash 320 included in the creation unit 312. In general, the amount of cash 320 equals the option strike price times a contract multiplier. If the cash 320 is held in an interest bearing account, the computer system calculates the total value of the cash 320 in the creation unit 312 on any day after creation to reflect principal value plus accrued interest.

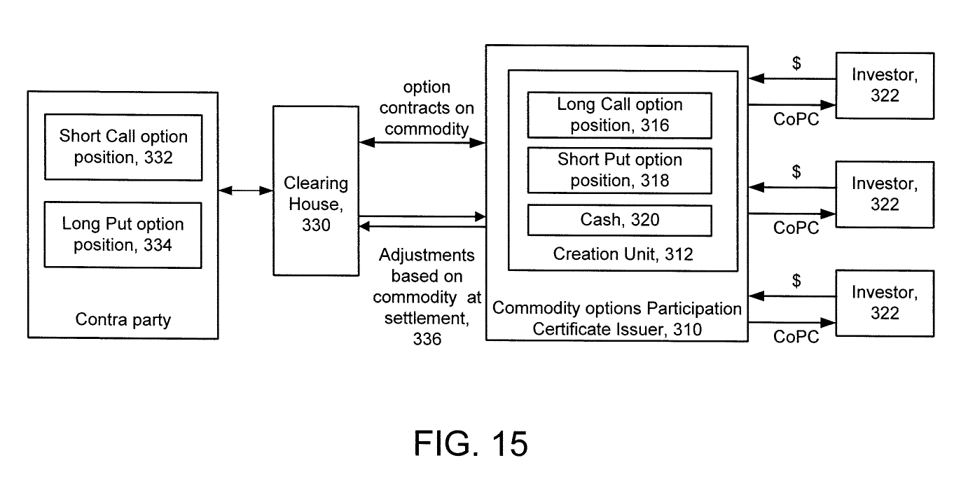

Referring to FIG. 15, in order to facilitate creation of Commodity option Participation Certificates 314, long call and short put options positions 316 and 318 are established by an investor seeking to generate Commodity option Participation Certificates and transferred with a requisite cash amount via a clearing house 330 to the Commodity option Participation Certificate issuer 310 in exchange for the newly issued Commodity options Participation Certificates. The Commodity option Participation Certificate issuer 310 receives the long call options positions 316 and the short put options positions 318 plus cash through accounts at the clearing house 330. Thus, the Commodity option Participation Certificate issuer 310 will have an increase in value in the long call/short put options and cash positions if the commodity rises in value and will have a decrease in value if the commodity falls in value by the expiration date.

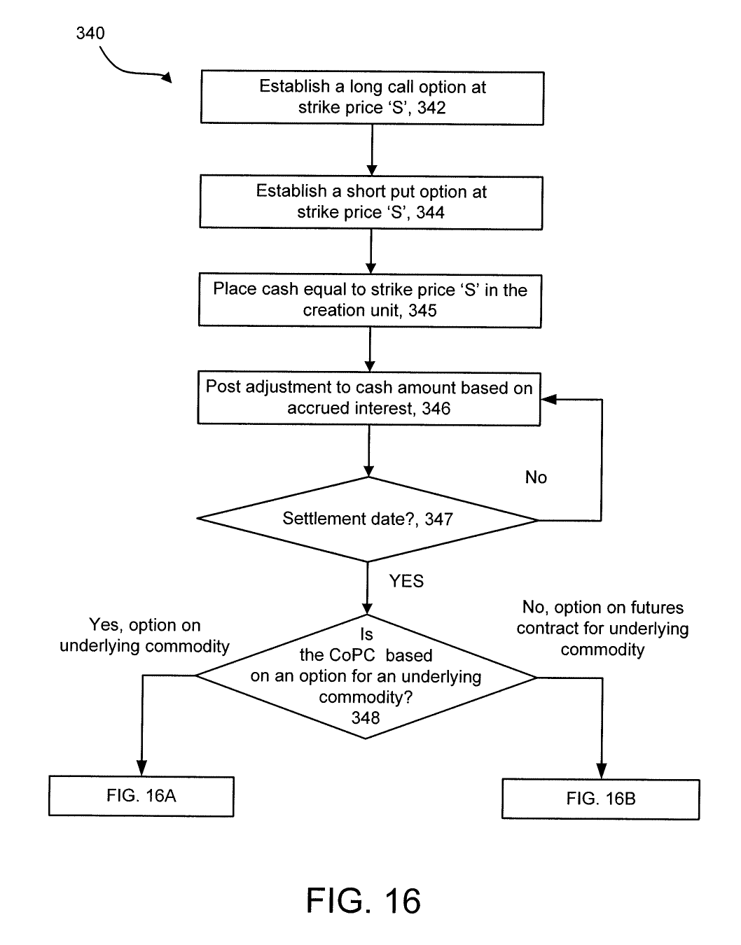

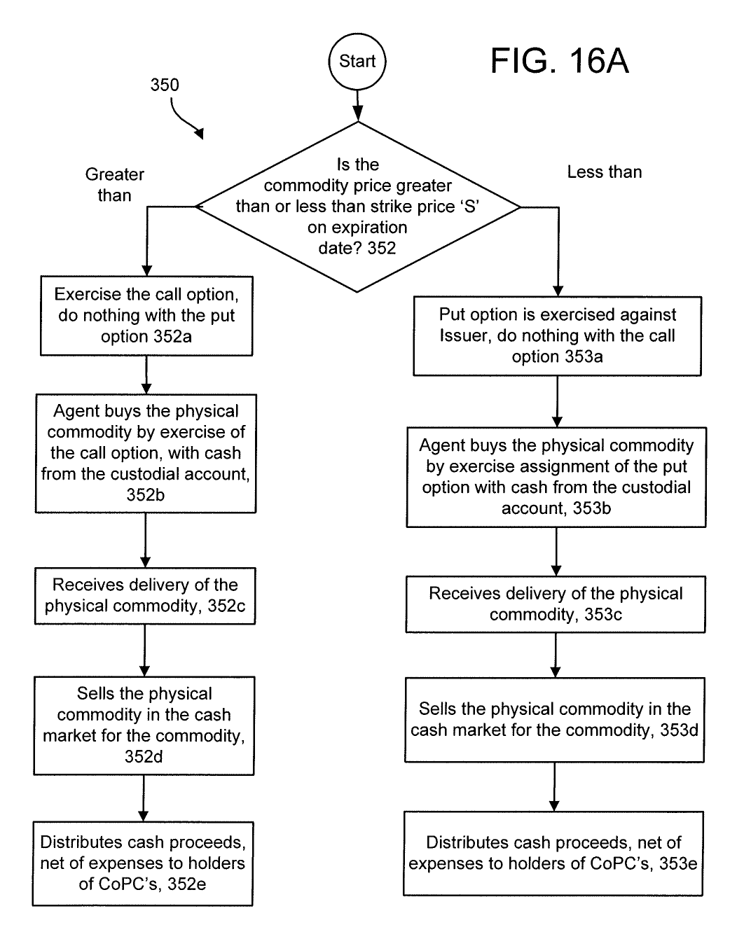

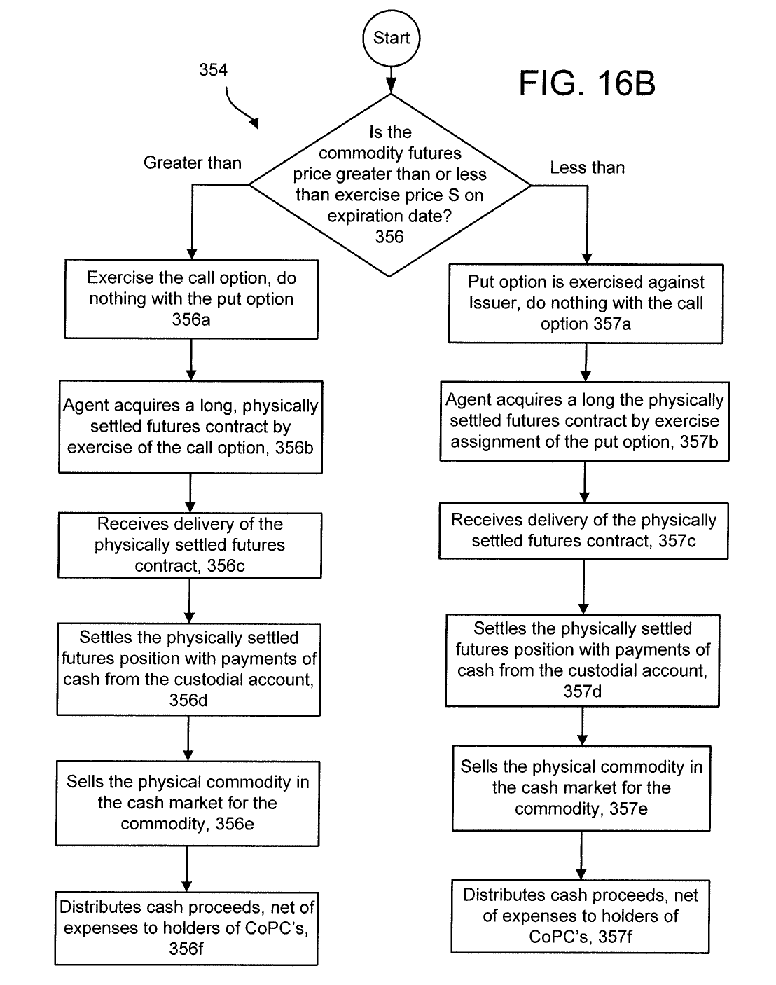

Both the long call and short put options positions 316 and 318 are established based on the same “strike price” for the options contracts and on the same expiration date. On the expiration date for the options contracts, if the value of the commodity is greater than the strike price, money is transferred from the clearing house 330 to the Commodity options Participation Certificates issuer 310 (as indicated by arrows 336 and described below in relation to FIGS. 16-18). Conversely, on the expiration date for the options contracts, if the value of the commodity is less than the strike price, money is transferred from the Commodity option Participation Certificate issuer 310 to the clearing house 330.

After the options positions 316, 318, 332, and 334 and cash have been delivered via the clearing house 330 to the Commodity option Participation Certificate issuer 310 the Commodity option Participation Certificate issuer 310 produces a creation unit 312. As described above, the creation unit 312 holds a long call and a short put options positions 316 and 318 and a predefined amount of cash 320. The amount of cash 320 included in the creation unit 312 equals the strike price for the options contracts 316 and 318 multiplied by a contract multiplier (if applicable). For example, if the strike price for the long call option position 316 is $1000 and the strike price for the short put options contract 318 is $1000 upon formation the creation unit would include $1000 multiplied by the contract multiplier (if any) for the options contracts.

Initially, upon the first generation of particular Commodity option Participation Certificates, the Commodity option Participation Certificates are valued based on the cash amount related to the pro-rata cash 320 in the creation unit 312 and the market price of the options contracts 316 and 318 at the time of first generation of the Commodity option Participation Certificates 314 after accounting for expenses and fees. Thus, the cost of the Commodity option Participation Certificate 314 is initially based on the strike price of the options contracts 316 and 318 for the commodity on the day of formation of the creation unit 312. If additional Commodity option Participation Certificates 314 are issued to investors 322 after the initial creation unit, a computer system calculates the amount of cash necessary to form a creation unit 312. The amount of cash will include any accrued interest such that the formation of the additional Commodity option Participation Certificates 314 does not dilute the value of the previously offered Commodity option Participation Certificates 314.

After issuance of the Commodity option Participation Certificate 314 by the Commodity futures Participation Certificate issuer 310, the Commodity option Participation Certificate 314 can be traded on an exchange, market, electronic communication network (ECN) and other trading venues. In order to facilitate open trading of the Commodity option Participation Certificates 314, the Commodity option Participation Certificates 314 can be listed and traded like ordinary shares of stock or exchange traded funds (ETFs) on one or more national securities exchanges and/or through the trading facilities of one or more electronic communication networks (ECNs).

Secondary market trading of Commodity option Participation Certificates 314 will be at prices governed by competitive supply and demand forces taking into consideration the values of the options contracts, cash, and value of the commodities that the Commodity option Participation Certificates 314 represents. Because the Commodity option Participation Certificates 314 are traded in a manner similar to traditional stocks on a national securities exchange, the Commodity option Participation Certificates 314 will be available to be traded and held through any ordinary stock brokerage account and handled by any one of the Registered Representatives in the United States today.

Since the creation unit 312 includes a long call option 316, a short put option 318, and a defined amount of cash 320 corresponding to the strike price of the options, the value of the Commodity option Participation Certificate 314 converges to the value of the underlying commodity on the expiration date of the options contracts 316 and 318. With this arrangement, the investment position represented by the Commodity option Participation Certificate 314 is economically equivalent to being long the underlying commodity on the options expiration date regardless of whether the commodity increases or decreases in value through that date. In order for the value of the Commodity option Participation Certificates 314 to converge to the value of the commodity on the settlement date, the strike price of the long call option 316 and the short put option 318 are the same.

For a call option, the payoff to a holder of a call option is:

| Exercise call | if V > s |
|---|---|
| 0 | if V = S |
| 0 | if V < S |

where V is the value of the commodity at expiration of the call option and S is the strike price for the call option.

For a put option, the payoff to a holder of the put option is:

| | |
|---|---|
| 0 | if V > s |
| 0 | if V = S |
| Exercise put | if V < S |

where V is the value of the commodity at expiration of the put option and S is the strike price for the option.

Since the Commodity futures Participation Certificate issuer 314 is short the put option, the Commodity futures Participation Certificate issuer 314 will be liable to accept delivery of (i.e., buy) the commodity should the value of the commodity be less than the strike price on settlement date.

| Forced to accept delivery | if V > s |
|---|---|
| 0 | if V = S |
| 0 | if V < S. |

Because the creation unit 312 includes cash equal to the strike price ‘S’, the value of the creation unit converges to the value of the commodity “V.” That is, regardless of whether ‘V’ is greater than ‘S,’ equal to ‘S’ or less than ‘S’ on expiration date, the value of the account holding the long call, short put, and cash equal to the strike price equals ‘V’ value of the commodity.

Referring to FIG. 16, a process 340 for issuing and redeeming Commodity option Participation Certificates is shown. The Commodity option Participation Certificate issuer 310 receives 342 a long call option having a particular strike price, referred to herein as strike price ‘S’ and receives 344 a short put option having the same strike price ‘S’. The Commodity option Participation Certificate issuer 310 also receives 345 an amount of cash equal to the strike price ‘S’ in the creation unit 312. Since the strike prices ‘S’ of the long call and short put options positions are the same and the creation unit 312 includes cash 320 equal to the strike price ‘S’, the value of the creation unit 312 converges to the value of the commodity on the date of expiration of the options after accounting for the multiplier.

As the value of the creation unit converges to the value of the commodity, on the expiration date, the Commodity option Participation Certificate issuer 310 uses a computer system to administer, monitor, and reconcile cash flows to account for accrued interest.

On the settlement date, the Commodity option Participation Certificates 314 are liquidated and a pro-rata share of cash is distributed to holders of the Commodity option Participation Certificates 314 using the following process.

After the accounts of the Commodity options Participation Certificate issuer and the contra-party 31 have been adjusted or if no adjustment is needed, 346 the computer system determines 347 if the current date is equal to the settlement date for the option contracts. If the date is not the settlement date, the determination of accrued interest and adjustment of the accounts is repeated.

If it is the settlement date, settlement varies on whether the physical deliverable is a commodity or a futures contract on the deliverable 348.

Settlement for Options on Physically Deliverable Commodity

Referring now to FIG. 16A, settlement processing 350 for a physically deliverable commodity is shown. If the date is the settlement date of an option for an underlying physical commodity, the issuer, custodian, or agent of the issuer or custodian facilitates distribution of cash proceeds upon maturity of Commodity option Participation Certificate by determining 352 if the commodity price is greater than or less than the strike price S on settlement date. If greater, then the issuer, custodian, or agent of the issuer or custodian exercises the call option and does nothing with the put option 352a. The issuer, custodian, or agent of the issuer or custodian buys the physical commodity by exercise of the call option, with cash from the custodial account, 352b that is paid to the writer of the call option, in exchange for receiving delivery 352c of the physical asset to settle the call option contract obligation. The issuer, custodian, or agent of the issuer or custodian, sells 352d, in the cash market, the physical asset underlying the physically settled options contract which was received to settle the physically settled options contract obligation, and distributes 352e cash proceeds, net of expenses, pro rata to Commodity option Participation Certificate holders.

Conversely, if the commodity price is less than the strike price S on settlement date, the issuer, custodian, or agent of the issuer or custodian has the put option exercised against it, and does nothing with the call option 353a. The issuer, custodian, or agent of the issuer or custodian buys 353b the physical commodity, by exercise assignment of the put option, with cash from the custodial account, which is paid through the clearing house to the holder of the long put option, in exchange for receiving delivery 353c of the physical asset to settle the put option contract obligation. The issuer, custodian, or agent of the issuer or custodian, sells 353d in the cash market, the physical asset underlying the physically settled options contract which was received to settle the physically settled options contract obligation, and distributes 353e cash proceeds, net of expenses, pro rata to Commodity option Participation Certificate holders.

Settlement for Options on Physically Settled Futures Contacts

Referring now to FIG. 16B, settlement processing 354 for a physically deliverable commodity is shown. If the date is the settlement date of an option for a physically settled futures contract, the issuer, custodian, or agent of the issuer or custodian facilitates distribution of cash proceeds upon maturity of Commodity option Participation Certificate by determining 356 if the commodity price is greater than or less than the strike price S on settlement date. If greater, then the issuer, custodian, or agent of the issuer or custodian exercises the call option and does nothing with the put option 356a. The issuer, custodian, or agent of the issuer or custodian acquires the physically settled futures contract 356b by exercise of the call option to settle the call option contract obligation.

The issuer, custodian, or agent of the issuer or custodian, accepts 356d delivery of the commodity underlying the physically settled futures contract and sells 356e the commodity in the cash market for the commodity underlying the physically settled futures contract which was received to settle the physically settled futures contract obligation, and distributes 356f the cash proceeds, net of expenses, pro rata to CoPC holders.

Conversely, if the commodity price is less than the strike price S on settlement date, the issuer, custodian, or agent of the issuer or custodian has the put option exercised against it, and does nothing with the call option 357a. The issuer, custodian, or agent of the issuer or custodian acquires 357b the physically settled futures contract by exercise assignment of the put option to settle the put option contract obligation. As before, the issuer, custodian, or agent of the issuer or custodian, accepts 357d delivery of the commodity underlying the physically settled futures contract and sells 357e the commodity in the cash market for the commodity underlying the physically settled futures contract which was received to settle the physically settled futures contract obligation, and distributes 357f the cash proceeds, net of expenses, pro rata to CoPC holders.

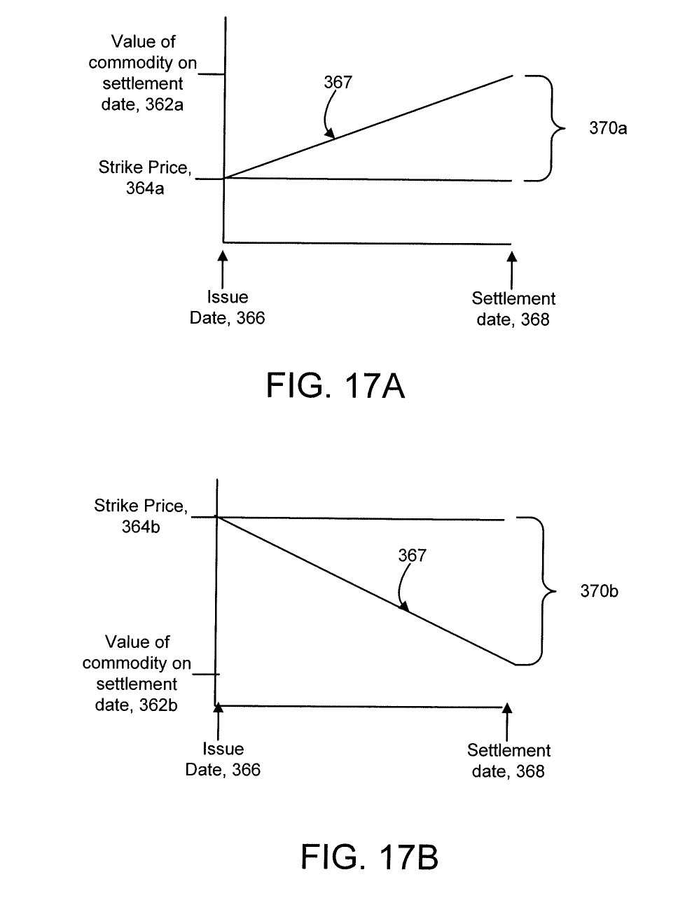

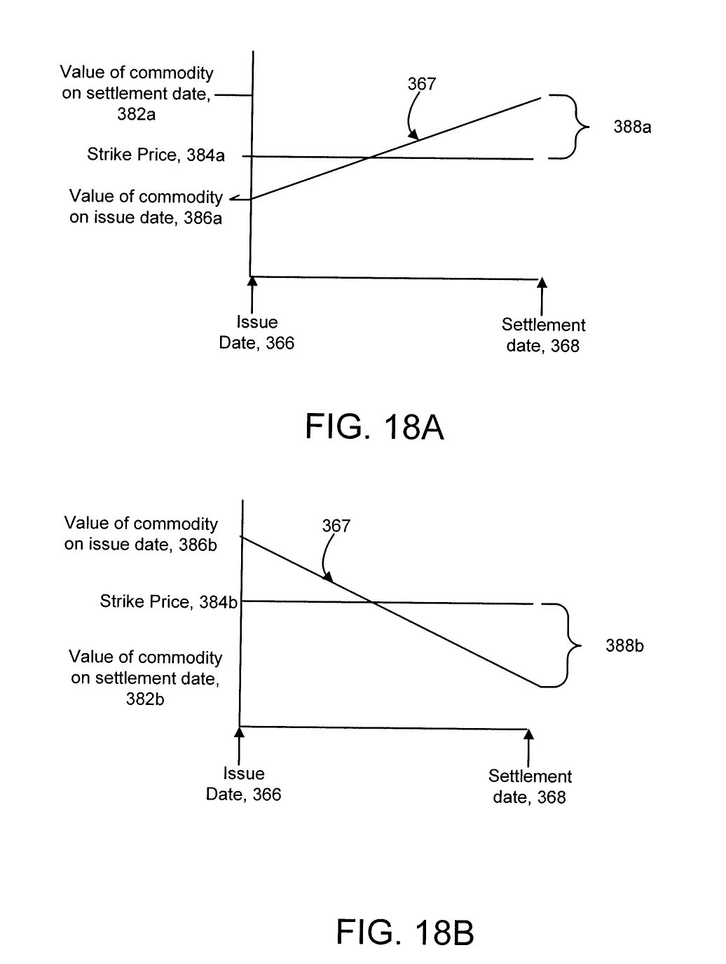

For example, if the commodity value is greater than the strike price on expiration date, the Commodity option Participation Certificate issuer exercises 350 the call option and the put option is not exercised 352. Conversely, if the commodity value is less than the strike price ‘S’ on expiration date, the put option is exercised 354 by its holder against the Commodity option Participation Certificate issuer 310 while the call option is not exercised 356. The computer system adjusts the amount of cash included in the creation unit 312 based on the exercised options and exercised settlement values. Examples are presented below in relation to FIGS. 17A, 17B, 18A, and 18B.

FIGS. 17A and 17B depict examples of the convergence of the value of the creation unit 312 and the commodity after accounting for the multiplier when the strike price for the options contracts 316 and 318 is the same as the value of the commodity on the date of generation of the creation unit 312.

Referring to FIG. 17A, an example is depicted in which the strike price 364a is equal to the value of the commodity on the issue date 366. In this example, the value of the commodity (represented by line 367) rises between the issue date 366 and the expiration date 368. At the expiration date 368, the value of the commodity is greater than the strike price of the options contract. Thus, the call option can be exercised 370a and the put option expires worthless. The economic payout value of the call option exercise transaction is determined by a computer and is the difference between the strike price to be paid on exercise to take delivery of the underlying physical asset and the value of the commodity on expiration date which corresponds to the proceeds of the sale of the commodity in the cash market that day.

Therefore, the value of the cash 320 in the creation unit 312 (e.g., the strike price plus the payout 370a from the call option) converges to the value of the commodity upon settlement.

Referring to FIG. 17B, the strike price 364b is equal to the value of the commodity on the issue date 366. In this example the value of the commodity (represented by line 367) decreases between the issue date 366 and the settlement date 368. At the settlement date 368, the strike price 364b of the options contracts is greater than the value of the commodity 362b. Thus, the call option expires worthless, and since the Commodity option Participation Certificate issuer 310 holds a short put option 318, the Commodity option Participation Certificate issuer 310 makes a payout 370b economically equivalent to the strike price minus the commodity value. The value of the cash 320 in the creation unit 312 (e.g., the strike price minus the economic payout value 370b from the put option exercise transaction) converges to the value of the commodity on the expiration date 368.

FIGS. 18A and 18B depict examples of the convergence of the value of the creation unit 312 and the commodity when the strike price for the options contracts 316 and 318 is different from the value of the commodity on the date of generation of the creation unit 312 are shown.

Referring to FIG. 18A, in this example the strike price 384a is different from the value of the commodity 386a on the issue date 366. In this example the value of the commodity (represented by line 367) rises between the issue date 366 and the expiration date 368. At the expiration date 368, the strike price 384a of the options contracts is less than the value of the commodity 382a. Thus, the put option expires worthless and the Commodity option Participation Certificate issuer 310, as the seller of the put option, does not owe any money to the buyer and the call option can be exercised. Thus, the value of the cash 320 in the creation unit 312 (e.g., the strike price plus the economic payout value 388a from the call option exercise transaction) converges to the value of the commodity 382a.

Referring to FIG. 18B, in this example the strike price 384b is different from the value of the commodity 386b on the issue date 366. In this example the value of the commodity (represented by line 367) decreases between the issue date 366 and the settlement date 368. At the settlement date 368, the strike price of the options contracts is greater than the value of the commodity 382b. Thus, the call option expires worthless and has a payout of $0. Because the Commodity option Participation Certificate issuer 310 is short the put option, the Commodity option Participation Certificate issuer makes a payout 388b economically equivalent to the strike price 384b minus the commodity value 382b. Thus, again, the value of the cash 320 in the creation unit (e.g., the strike price minus the economic payout value 388b from the put option exercise transaction) converges to the value of the commodity 382b on the expiration date 368.

As shown in the examples above, in order for the value of the options 316 and 318 and the cash 320 included in the creation unit 312 to converge to the value of the commodity on the expiration date, the options have the same strike price and expiration date the amount of cash 320 included in the creation unit 312 is set initially equal to that strike price. However, at any given time there are multiple options available on the market with the same expiration date but different strike prices.

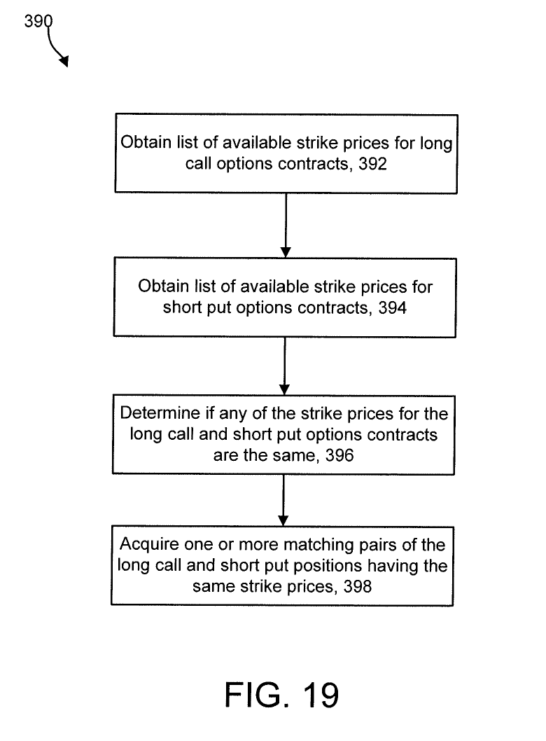

Referring to FIG. 19, a process 390 for obtaining long call option contracts 316 and short put options contracts 318 having the same strike price and expiration date is shown. The Commodity option Participate Certificate issuer 310 uses a computer to obtain 392 a list of available strike prices for call options 316 having a particular expiration date and to obtain 394 a list of available strike prices for put options 318 having the same expiration date. The computer system determines 396 if any of the strike prices for a long call option contract and a short put option contract are the same. If at least some matching strike prices are located, the computer system instructs the Commodity option Participate Certificate issuer 310 to accept 398 one or more of the matching pairs of long call and short put options having the same strike price and the same expiration date in the creation unit in exchange for newly issued Commodity option Participate Certificates.

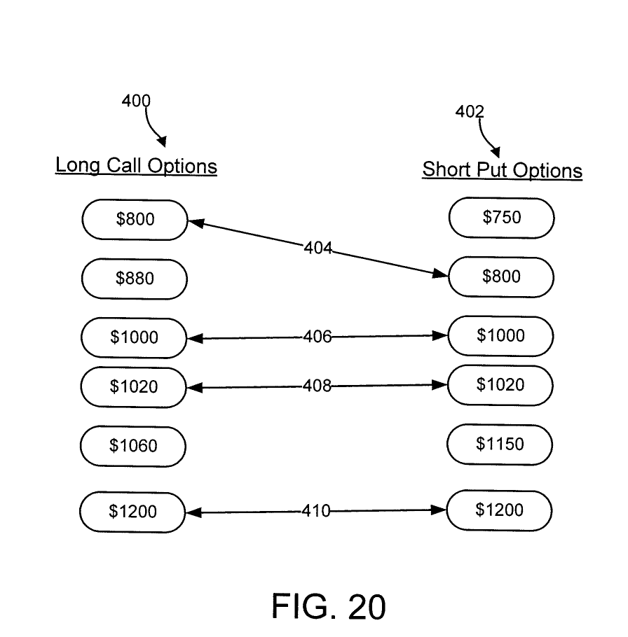

Referring to FIG. 20, an exemplary listing of strike prices for long call and short put options is shown. The long call options (shown in column 400) include long call options having strike prices of $800, $880, $1000, $1020, $1060, and $1200. The short put options (shown in column 402) include short put options having strike prices of $750, $800, $1000, $1020, $1150, and $1200. In order to determine the matching pairs of options, the computer system obtains both of these lists. After analyzing the strike prices, the computer system would determine that matching pairs exist at the strike prices of $800, $1000, $1020, and $1200 (as indicated by arrows 404, 406, 408, and 410, respectively). The Commodity option Participation Certificates issuer 310 receives one or more long call and short put options pairs having the same strike price and expiration date to provide a creation unit basis for issuance of Commodity option Participation Certificates 314.

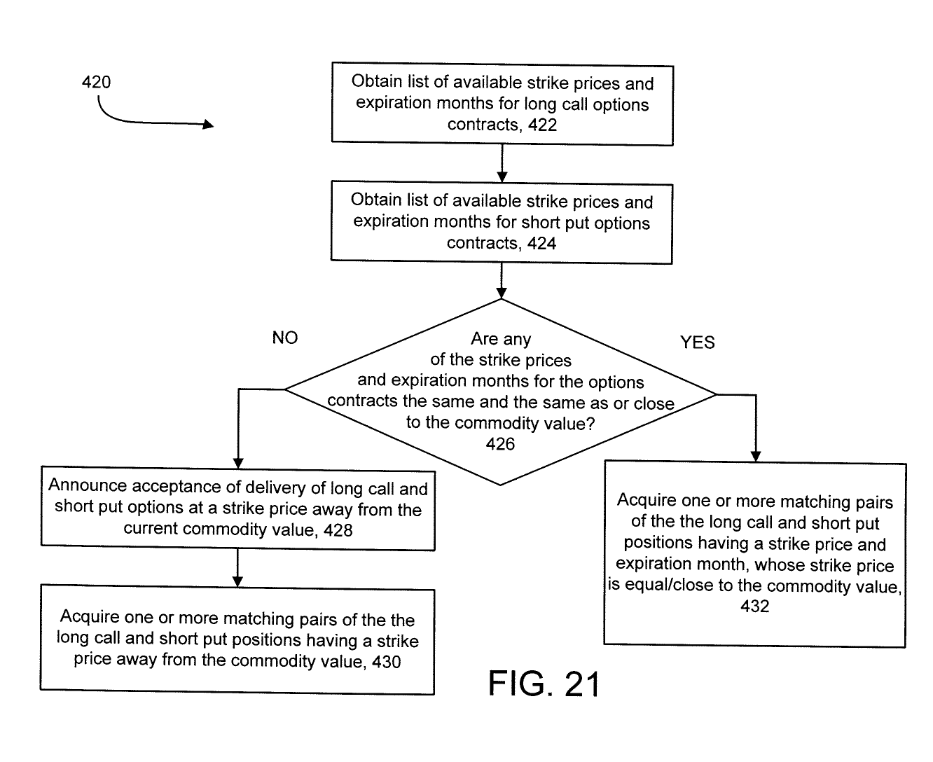

Referring to FIG. 21, a process 420 for obtaining long call option contracts and short put options contracts having strike prices equal to the commodity value at the issue date and having the same settlement date is shown. The Commodity option Participation Certificate issuer 310 uses a computer system to obtain 422 a list of available strike prices for long call options having a particular expiration date and to obtain 424 a list of available strike prices for short put options having the same expiration date. The computer system determines 426 if any of the strike prices for the long call and short put options contracts are the same as (or within a certain percentage of) the current value of the commodity. If one or more matching pairs of long call and short put options having a strike price equal to (or about the same as) the commodity value are located, the computer system instructs the Commodity option Participation Certificate issuer 310 to accept 432 at least one of the matching pair(s) of long call and short put options. If such matching pairs are not located, the Commodity option Participation Certificate issuer 310 announces 432 that it will accept delivery of long call and short put options at a strike price away from the current commodity value. The Commodity option Participation Certificates issuer 310 acquires 430 from Commodity option Participation Certificate requesters one or more matching pairs of the long call and short put options.

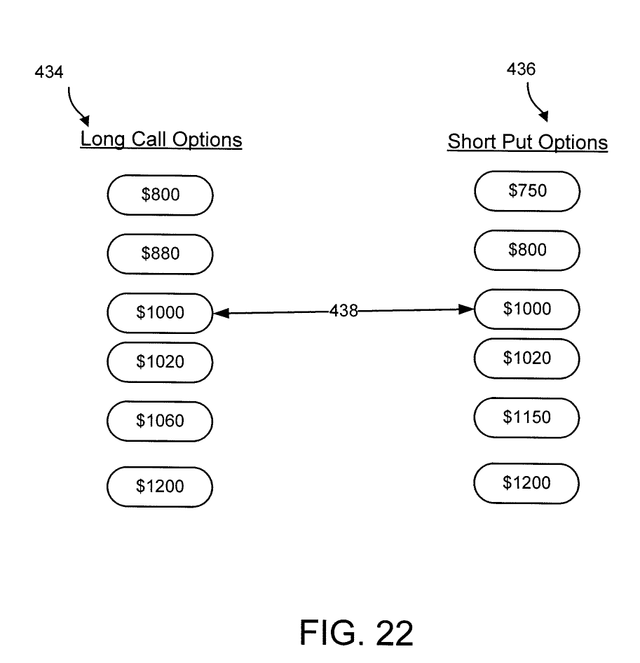

Referring to FIG. 22, an exemplary listing of strike prices for long call and short put options is shown. The long call options (shown in column 434) include long call options having strike prices of $800, $880, $1000, $1020, $1060, and $1200. The short put options (shown in column 436) include short put options having strike prices of $750, $800, $1000, $1020, $1150, and $1200. If the current value of the commodity was $1000, the computer system analyzes the lists 434 and 436 and determines that a matching pair of long call and short put options exist at a strike price equal to the value of the commodity, namely a strike price of $1000 (as indicated by arrow 438). The Commodity option Participation Certificate issuer 310 purchases the long call and short put options having the same strike price.

While in the examples described above the long call and short put options included in the creation unit 310 had the same strike price, in some embodiments the long call and short put options included in the creation unit 310 can have different strike prices. In such embodiments, the value of the Commodity option Participation Certificates issued based on the creation unit does not necessarily converge to the value of the commodity on settlement date. In order to guarantee the commodity value to the holders of the Commodity option Participation Certificates, the Commodity option Participation Certificate issuer 310 uses a computer system to calculate a valuation to determine what supplementary amount of cash credit or debit to include in the creation unit after accounting the difference in value due to differences in strike prices. In order to calculate the valuation, the computer system would determine the amount by which the value of the creation unit would exceed or fall short of the value of the commodity on expiration date. The computer system would also adjust the cash amount corresponding to strike price and multiplier to offset the excess value or the shortfall in value in order to help ensure the Commodity option Participation Certificates converges in value with the commodity.

While in the examples described above the long call and short put options included in the creation unit 310 had the same expiration date, in some embodiments the long call and short put options included in the creation unit 310 can have different expiration dates. In such embodiments, the value of the Commodity option Participation Certificates issued based on the creation unit does not necessarily converge to the value of the commodity on expiration date. In order to guarantee the commodity value to the holders of the Commodity option Participation Certificates, the Commodity option Participation Certificate issuer 310 uses a computer system to calculate a valuation to determine what supplementary amount of cash credit or debit to include in the creation unit after accounting the difference in value due to differences in expiration dates. In order to calculate the valuation, the computer system would determine the amount by which the value of the creation unit would exceed or fall short of the value of the commodity on expiration date. The computer system would also adjust the cash amount corresponding to strike price and multiplier to offset the excess value or the shortfall in value in order to help ensure the Commodity option Participation Certificates converges in value with the commodity.

Redemption/Settlement of Commodity option Participation Certificate

Similar to the situation described above in relation to the Commodity future Participation Certificates 22 issued based on a creation unit 20 that includes a futures contract 24 and a defined amount of cash 20, Commodity option Participation Certificates 314 based on long call/short put options 316 and 318 and cash 320 can have either a fixed term or a variable term.

For Commodity option Participation Certificates 314 having a fixed term, the term coincides with the specific monthly or quarterly expiration date of the corresponding options contracts that are used in the creation unit 312.

For Commodity option Participation Certificates 314 having a variable term, holders may exercise a cash-out, e.g., on a quarterly basis. If the holder of the Commodity option Participation Certificates 314 elects not to cash-out the Commodity option Participation Certificates, the Commodity option Participation Certificates 314 are automatically rolled forward into new Commodity option Participation Certificates. The new Commodity option Participation Certificates are issued through rule-driven market execution by the Commodity option Participation Certificates issuer 310. The certificates approximately correspond in underlying notional value to the remaining aggregate cash from the liquidated Commodity option Participation Certificates held by Commodity option Participation Certificate issuer.

In some embodiments, a Commodity option Participation Certificate holder may redeem Commodity option Participation Certificates 314 from the Commodity option Participation Certificate issuer 310 prior to the expiration date.

If the Commodity option Participation Certificate holder does not own a creation unit-size aggregation of Commodity option Participation Certificates, redemption is not feasible. In such a situation, the Commodity option Participation Certificate holder can trade, i.e. sell, the Commodity option Participation Certificates 314 on an exchange, market or other trading venue obtain a current value for the Commodity option Participation Certificates 314 prior to the settlement date.

On the other hand, if the Commodity option Participation Certificate holder owns a creation unit-size aggregation of Commodity option Participation Certificates and requests to redeem the Commodity option Participation Certificates 314 prior to expiration of the options contracts, the Commodity option Participation Certificate issuer 310 uses a computer to calculate the cash value for the creation unit of Commodity option Participation Certificates 314. Since the expiration date of the long call and short put options contracts 316 and 318 has not yet arrived, the Commodity option Participation Certificate issuer 310 transfers the long call and short put options contracts 316 and 318 in the creation unit 312 and the requisite cash value 320 after accounting for any fees to the Commodity option Participation Certificates holder in exchange for the Commodity option Participation Certificates 314.

### Creation Unit Including Multiple Long Call and Short Put Options

While the creation unit 312 in the embodiments described above has been described as including a long call option and a short put option based on a single commodity, other arrangements are possible. For example, the creation unit 312 could include a blend of options contracts for multiple different commodities.

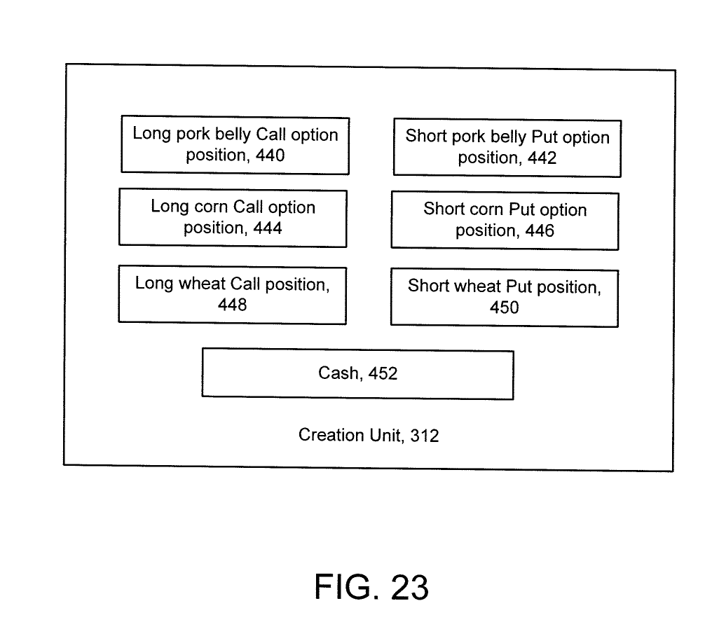

In one particular example, as shown in FIG. 23, the creation unit 312 includes weighted amounts of each of three different foodstuffs commodities, e.g., pork bellies, corn and wheat. The creation unit 312 includes a long pork bellies call option 440, a short pork bellies put option 442, a long corn call option 444, a short corn put option 446, a long wheat call option 448, and a short wheat put option 450. The creation unit 312 also includes a defined amount of cash 452. Upon formation of the creation unit 312, the value of the cash 452 would be a sum of the strike prices for the pork belly options, the corn options, and the wheat options after applying the respective contract multipliers.

Commodity option Participation Certificates based on a blend of different physically settled options could also be based on other commodity groupings.

### Creation Unit Including Multiple Options Contracts (Magnified Commodity Option Participation Certificate)

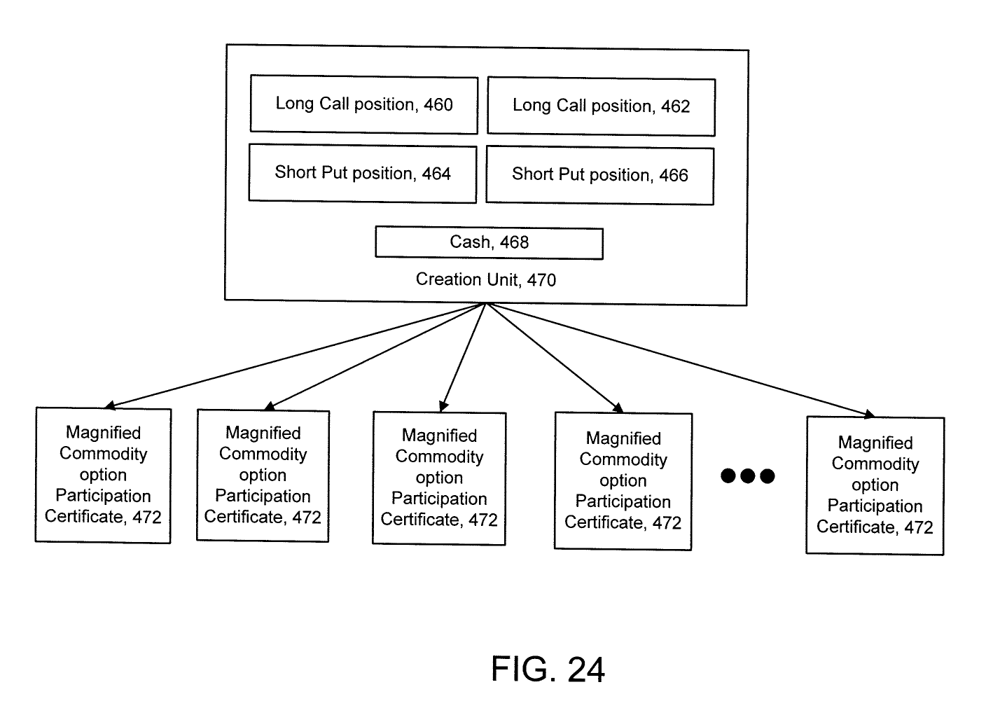

Referring to FIG. 24, in some embodiments, a creation unit 470 can include multiple long, call and multiple short, put physically settled options contracts based on the commodity and the same strike price and expiration month. In the example shown in FIG. 24, the creation unit 470 includes two long call pork belly options contracts 460 and 462 and two short put pork belly options contracts 464 and 466. The creation unit 470 also includes a defined amount of cash 468 equal to the strike price of one of the options contracts multiplied by the contract multiplier.

For example, if the options contracts 460, 462, 464, and 466 each have a strike price of $1500, $1500 multiplied by the multiplier would be included as the cash 468 in the creation unit 470. These multiple options contracts 460, 462, 464, and 466 increase the leverage of the Commodity option Participation Certificate by magnifying the position taken by the options contracts.

When the creation unit 470 includes two long call options contracts 460 and 462 and two short put options contracts 464 and 466 (i.e., two pairs in contrast to one as described above) and the cash 468 in the creation unit 470 is the strike price of a single one of the contracts, for each 1% by which the value of the commodity increases above the strike price by expiration date, the value of the Commodity option Participation Certificates 246 increases by about 2%. Similarly, for each 1% by which the value of the decreases below the strike price by expiration date, the value of the magnified Commodity option Participation Certificates 472 decreases by about 2%. Thus, the number of long call and short put options contracts included in the creation unit 470 serves as a multiplier to the gains/losses incurred by the magnified Commodity option Participation Certificate 472.

The number of options contracts in the creation unit 470 for the magnified Commodity option Participation Certificates 472 can vary. For example, the Commodity option Participation Certificate issuer 310 could issue magnified Commodity option Participation Certificates 472 with between two and twenty long call and short put commodity options contracts included in the creation unit 470. By way of illustration, if the creation unit 470 includes ten long call and short put options contracts, a one percent increase in the value of the commodity above the strike price on the expiration date would generate a corresponding ten percent increase (approximately) in the value of the creation unit 470 above the strike price on which the magnified Commodity option Participation Certificates 472 are based on the expiration date.

While in the above example, the magnified Commodity option Participation Certificate provides a multiply enlarged return based on a change in the value of the commodity, in some embodiments, a magnified Commodity option Participation Certificate provides a multiply enlarged return if the opposite of the movement of the value of the commodity. For example, for each 1% by which the value of the commodity decreases below the strike price by the expiration date, the value of the Commodity option Participation Certificates increases by about 2%. Similarly, in some embodiments, for each 1% by which the value of the commodity decreases below the strike price by expiration date, the value of the magnified Commodity option Participation Certificates increases by about 2%. Thus, the number of short call and long put physically settled options contracts included in the creation unit serves as a multiplier to the gains/losses incurred by the magnified Commodity option Participation Certificate.

The number of options contracts in the creation unit for the magnified bear Commodity option Participation Certificates can vary. For example, the Commodity option Participation Certificate issuer 310 could issue magnified bear Commodity option Participation Certificates 472 with between two and twenty long put and short call physically settled options contracts included in the creation unit 470.

### Creation and Redemption Arbitrage

In some embodiments, issuance and subsequent trading of the Commodity option Participation Certificates 314 may result in the Commodity option Participation Certificates trading at a slight premium or discount to the physically settled options contracts. When the Commodity option Participation Certificates are trading at a slight premium or discount, an arbitrageur could use the situation to arbitrage based on the premium or discount.

If the Commodity option Participation Certificates are trading at above the value corresponding to the current pork belly call options premium minus the current pork belly put options premium plus the cash amount equal to the options contract strike price times the contract multiplier (after accounting for transaction costs), an opportunity for creation unit arbitrage exists. In this situation, the arbitrageur would sell one creation unit worth of pork belly Commodity option Participation Certificates at the premium price on an exchange, market or other trading venue and buy one pork belly call option contract, and sell one pork belly put option contract to lock in the differential in the values of the Commodity option Participation Certificates and the value of the creation unit composed of the long pork belly call option and short pork belly put option.

The arbitrageur would request the creation of one creation unit of newly-issued pork belly Commodity option Participation Certificates from the Commodity option Participation Certificate Issuer. The arbitrageur would deliver out (via clearing house transfer) open pork belly options positions plus cash equal to the strike price plus accrued interest as applicable to the Commodity option Participation Certificate Issuer on an appropriate settlement timeline and receive one creation unit of newly issued pork belly Commodity option Participation Certificates from Commodity option Participation Certificate Issuer to cover the sale on the exchange, market, etc. on settlement. The arbitrageur also receives more than enough cash proceeds from the sale of Commodity option Participation Certificates to meet its cash delivery requirements, with the excess proceeds representing arbitrage profit from the creation transaction.

Conversely, if the Commodity option Participation Certificates are trading below the value equal to the current pork belly call options premium minus the current pork belly put options premium plus the cash amount equal to the options contract strike price times a contract multiplier, an opportunity for redemption arbitrage exists. In this situation the arbitrageur buys a creation unit aggregation of Commodity option Participation Certificates at the discount price on the exchange or market or other trading venue, sells one call option contract, and buys one put option contract to lock in the differential in the value between the current creation unit composed of the long pork belly call options, short pork belly put options, and cash, and the value of the Commodity option Participation Certificates.

The arbitrageur requests redemption of the creation unit aggregation of just-purchased Commodity option Participation Certificates from the Commodity option Participation Certificate Issuer. The arbitrageur delivers out (via clearing house transfer) a creation unit of Commodity option Participation Certificates to the Commodity option Participation Certificate Issuer and as redemption proceeds receives one long call option plus 1 short put option position plus cash corresponding to the strike price (after applying the multiplier) plus accrued interest net of expenses from the Commodity option Participation Certificate Issuer to cover settlement of the options trades and Commodity option Participation Certificate on an appropriate settlement timeline and with net excess cash representing arbitrage profit from the redemption transaction.

### Creation Unit Including Long Put Options and Short Call Options Contracts (Bear Commodity Option Participation Certificate)

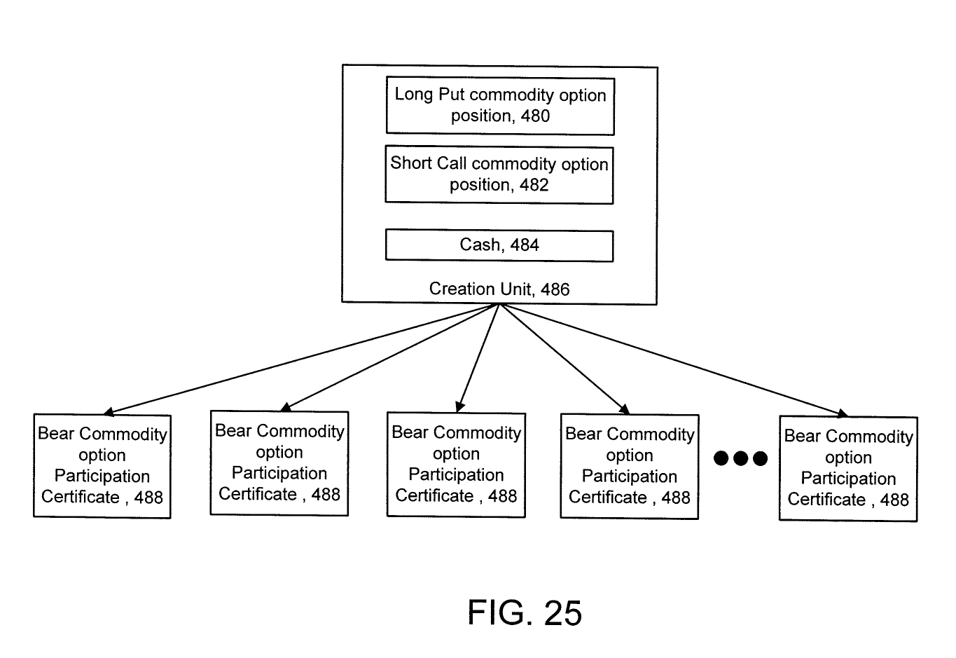

Referring to FIG. 25, while in some of the examples described above the creation unit (e.g., creation unit 312) included long call/short put physically settled options contracts, in some embodiments, e.g., a “bear” embodiment a creation unit 486 can include a short call physically settled option 482 and a long put physically settled option 480 having the same strike price and expiration date. The performance of these so called “bear” Commodity option Participation Certificates 488 based on creation unit 486 will have an inverse relationship to the performance of the commodity. Thus, if the commodity decreases, the value of the bear Commodity option Participation Certificates 488 will increase, and if the commodity increases the value of the bear Commodity option Participation Certificates 488 will decrease.

The creation unit 486 also includes a defined amount of cash 484. As the value of the creation unit converges to the commodity, on the expiration date, the Commodity option Participation Certificate issuer 310 uses a computer system to administer, monitor, and reconcile cash flows depending on whether the price is greater than, equal to, or less than the strike price. For example, if the commodity value is greater than the strike price on expiration date, the Commodity option Participation Certificate issuer exercises the put option and the call option is not exercised. Conversely, if the commodity value is greater than the strike price on expiration date, the call option is exercised by its holder, against the Commodity option Participation Certificate Issuer while the put option is not exercised. The computer system adjusts the amount of cash included in the creation unit based on accrued interest and on the exercised options as applicable.

### Balanced-Asset Options Based Commodity Option Participation Certificate

In some embodiments, a creation unit could blend physically settled options contracts for diversified commodity exposure in pre-determined, weighted amounts. In general, the creation unit could include any physically-settled options contract.

### Upside Participation/Downside Protection Commodity Option Participation Certificate

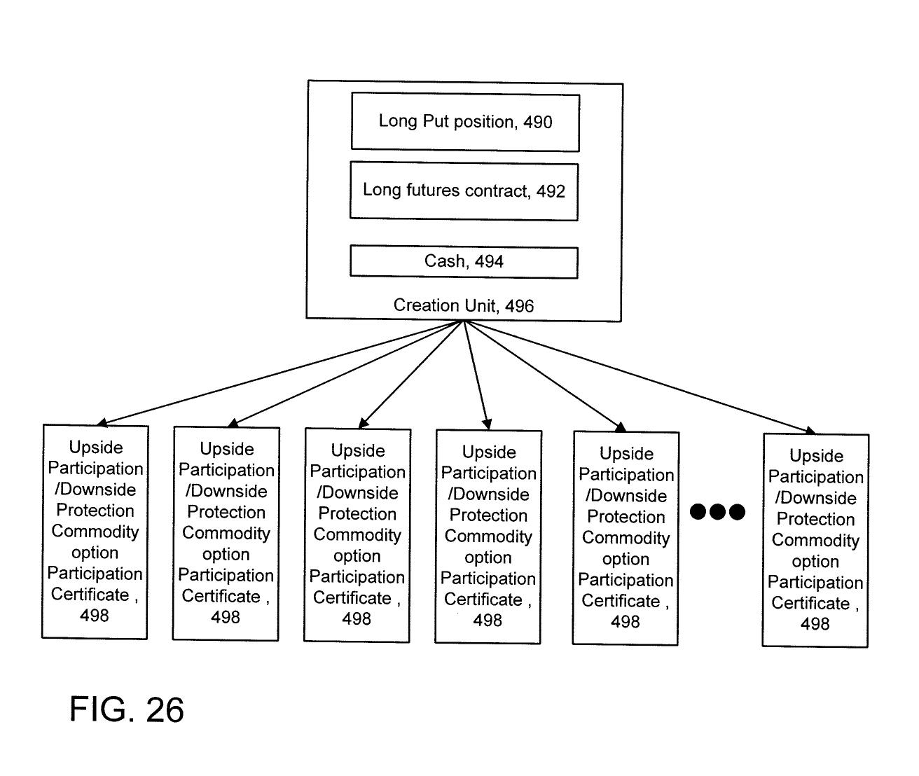

Referring to FIG. 26, in some embodiments the Commodity option Participation Certificates are upside participation/downside protection Commodity option Participation Certificates 498 that provide gains, should the value of the commodity increase and provide protection of the initial investment should the value of the commodity decrease. Such upside participation/downside protection Commodity option Participation Certificates 498 are based on a creation unit 496 that could include a long physically settled put option position 490 or a long physically settled futures put option position to provide protection when the underlying commodity falls in value and a long physically settled futures contract 492 to provide gains when the underlying commodity rises in value. The long put option (or futures put option) 490 will have a strike price corresponding to the value of the underlying commodity below which the investor wishes to be protected against adverse price movements. The creation unit 496 also includes a defined amount of cash 494 corresponding to the mark price (and accrued interest) for the futures contracts.

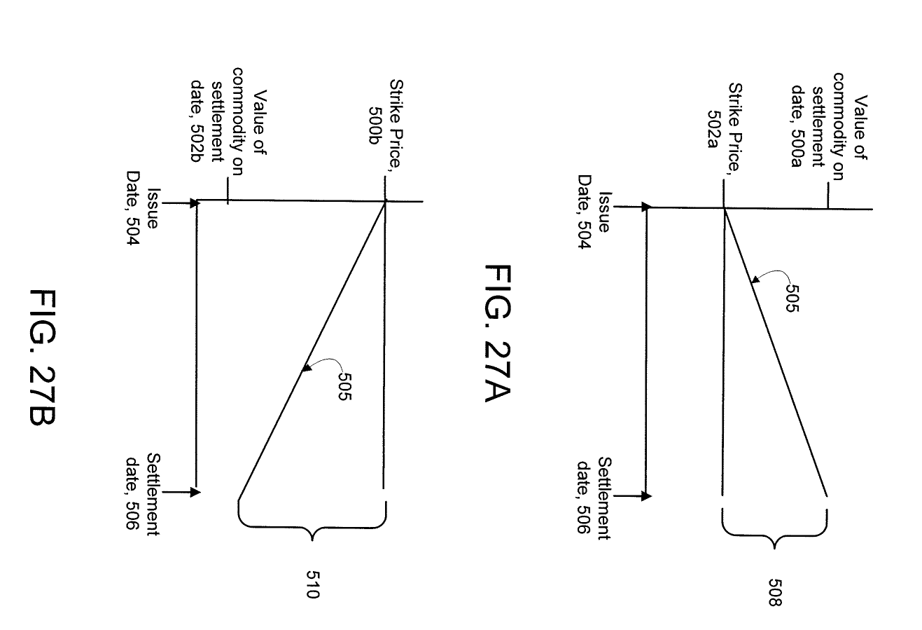

Referring to FIG. 27A and 27B, examples of the value of the creation unit 496 versus the performance of the commodity (indicated by line 505), for upside participation/downside protection Commodity option Participation Certificates 496 based on a creation unit 496 that includes a long physically settled put option 490 (or long put physically settled futures option) and a long physically settled put futures option contract position 492 is shown. In this example, the strike price 502a for the long put option 490 is the same as the mark price 502a for the long futures contract 492 on the date of generation of the creation unit 496.

In the example shown in FIG. 27A, the value of the commodity (represented by line 505) rises between the issue date 504 and the settlement date 506. At the settlement date 506, the strike price of the options contracts 502a is less than the value of the commodity 500a. Thus, the put option expires worthless (i.e. has a profit of $0). However, since the mark price for the long commodity futures 502a is less than the value of the commodity 500a, a payout 508 is gained from the long futures contract 492. Thus, the value of the cash 494 in the creation unit 496 (e.g., the strike price plus the economic payout value 508 from the futures contract) is equal to the value of the commodity 500a.

In the example shown in FIG. 27B, the value of the commodity (represented by line 505) falls between the issue date 504 and the settlement date 506. At the settlement date 506, the strike price 500b of the options contract is greater than the value of the commodity 502b. As such, the long put option 490 has a payout 510 economically equivalent (aside from transaction costs) to the strike price minus the commodity value. The futures contract has a loss equal to the strike price minus the commodity value. Thus, the value of the payout from the long put option 490 and the loss from the long futures 492 is approximately zero and the value of the Commodity option Participation Certificate on settlement date is equal to the strike price. As such, the upside participation/downside protection Commodity option Participation Certificate 498 is shown to protect the investment of the note holder from the decrease in the value of the commodity below the strike price.

### Upside Participation/Downside Protection Commodity Option Participation Certificates

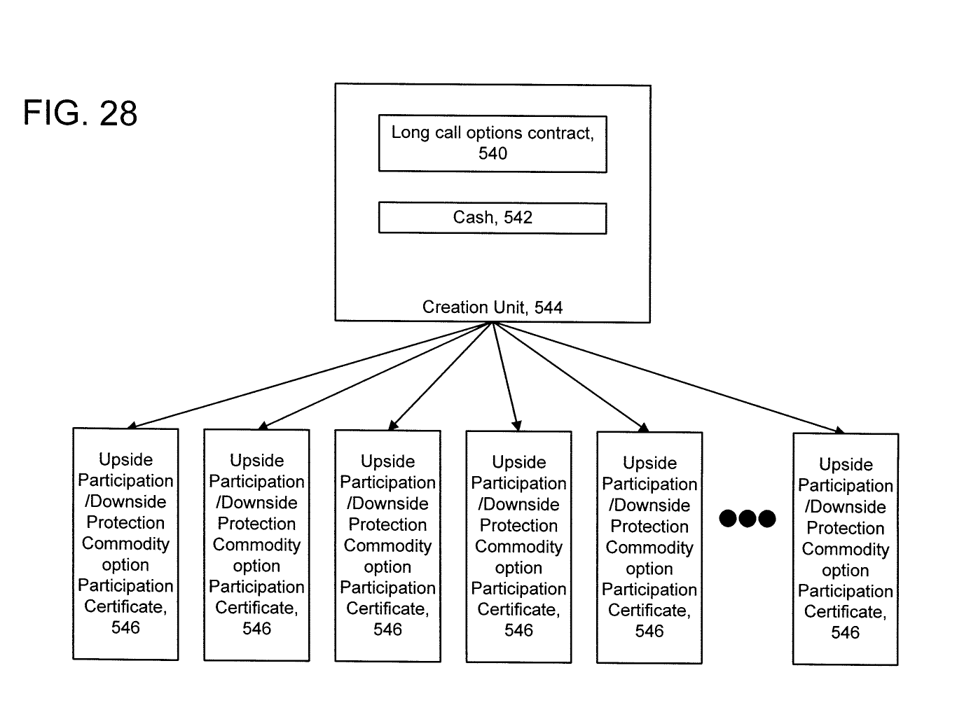

Referring to FIG. 28, in some embodiments, Commodity option Participation Certificates 546 are based on a creation unit 544 that includes a long call options contract 540 to provide the upside gains. The creation unit 544 also includes a defined amount of cash 542 equal to the strike price for the long call options contract.

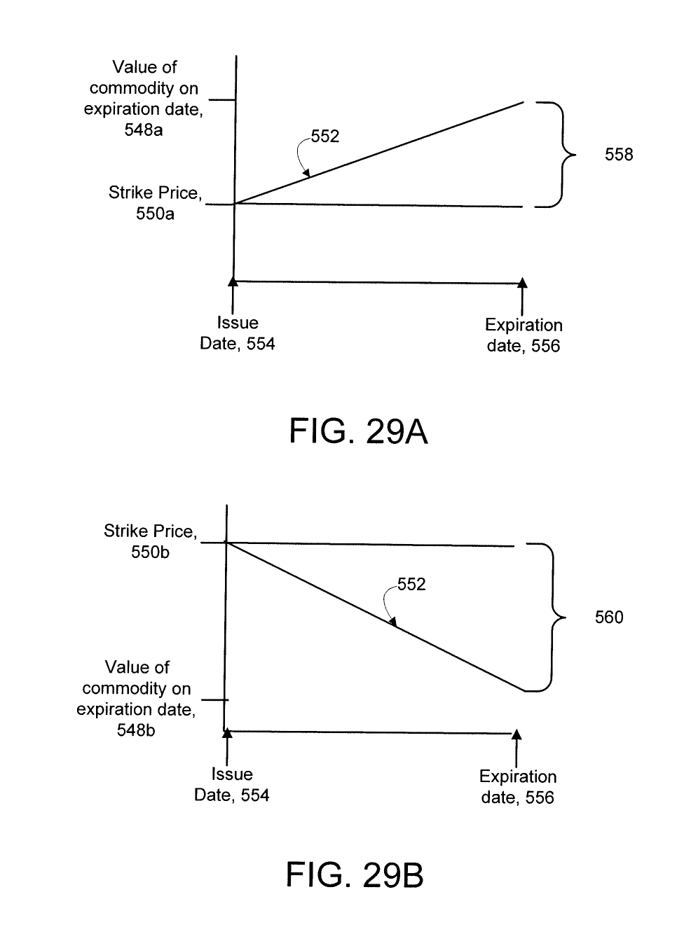

Referring to FIG. 29A and 29B, examples of the value of the creation unit 544 versus the performance of the commodity (indicated by line 552), for upside participation Commodity option Participation Certificate 546 based on a creation unit 544 that includes a long call option 540 (or futures option) and cash 542 is shown.

In the example shown in FIG. 29A, the value of the commodity (represented by line 552) rises between the issue date 554 and the expiration date 556. At the expiration date 556, the strike price of the options contracts 550a is less than the value of the commodity 548a. Thus, the long call option or futures option has a payout economically equivalent to the difference between the commodity 548a and the strike price 550a (represented by arrow 558).

In the example shown in FIG. 29B, the value of the commodity (represented by line 552) falls between the issue date 554 and the option expiration date 556. At the expiration date 556, the strike price 550b of the long call options contract is greater than the value of the commodity 502b. As such, the long call option expires worthless. Thus, at the expiration date 556, the Commodity option Participation Certificate has a value equal to the pro-rata share of the cash 542 included in creation unit 544 which corresponds to the strike price. The value of the Commodity option Participation Certificate is not further reduced by the decrease in the value of the commodity, providing downside protection.

### Buy/Write Commodity Participation Note

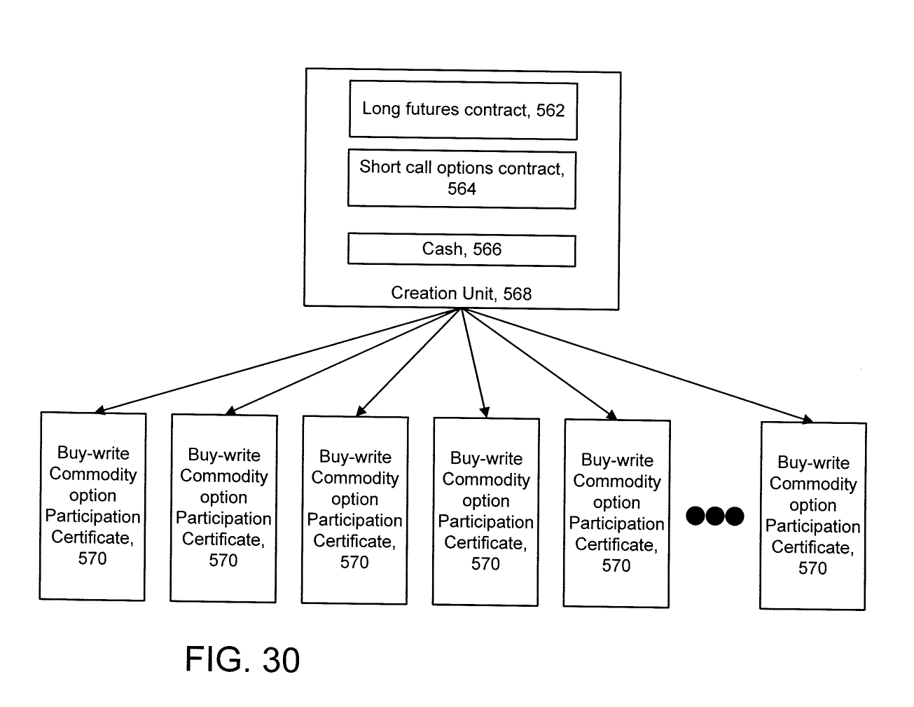

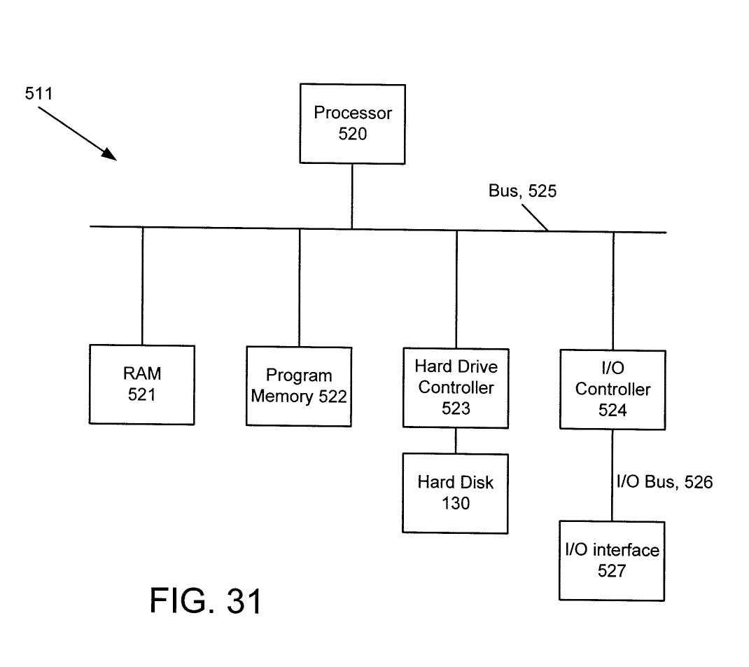

Referring to FIG. 30, in some embodiments the Commodity option Participation Certificates are buy/write Commodity option Participation Certificates 570 that provide an economic cash benefit when the underlying commodity increases in value but not above the strike price from the issue date to the settlement date (e.g., when the market is ‘flat’ or trades within a specified range). Such buy/write Commodity option Participation Certificates 570 are based on a creation unit 568 that includes a long physically settled futures contract 562 and an amount of cash 566 equal to the mark price for the long physically settled futures contract 562. The combination of the long physically settled futures contract 562 and the cash 566 provides for a return corresponding to the commodity return (as described above). The creation unit also includes a short physically settled call options contract 564 or short physically settled futures call option. When the Commodity option Participation Certificate issuer writes the short call options contract 564, the Commodity option Participation Certificate issuer receives the options premium or proceeds from the sale to the party that purchases the long position. Thus, an economic cash benefit is made from writing the short call options contract 564.

Buy/write Commodity option Participation Certificates 570 provide an economic cash benefit if the commodity increases in value up to but not above the strike price of the options or futures options which were sold. If the commodity increases in value above the strike price, the gains from the long futures contract 562 and the loss from the short call options contract 564 offset each other such that there are no gains or losses for increases in commodity value above the strike price. If the commodity decreases in value, the value of the buy/write Commodity option Participation Certificates 570 track the commodity value.

While in the example of a buy/write Commodity option Participation Certificates 570 described above, the creation unit included a long futures contract 562 and a defined amount of cash 566, other positions equivalent in value to a long position could be substituted for the long futures contract 562 and defined amount of cash 566. For example, the creation unit could include a long call options contract, a short put options contract with a strike price different from the strike price of the short call option or short call futures option, and an amount of cash equal to the strike price of the options contracts.

### Distributions

As described above, the cash included in a creation unit (e.g., cash 26 in creation unit 20, cash 320 in creation unit 312) for the Commodity option Participation Certificates is invested in interest bearing investments. For example, the cash can be held in U.S. Treasury bills or notes that guarantee a fixed return over a predefined period of time. The net profit of interest gained on the cash is periodically distributed to the holders of the Commodity option Participation Certificate, e.g., quarterly, semi-annually, or annually. In some embodiments, the yield on cash held in U.S. Treasury bills in the Issuer's Custody Account can accrue and is distributed to Commodity option Participation Certificate holders on final redemption, expiration, or settlement of the Commodity option Participation Certificate in lieu of quarterly stock dividends.

The system and methods described herein can be implemented in digital electronic circuitry, or in computer hardware, firmware, software, or in combinations thereof. For example, calculations of the cash value for a creation unit, the formation of a creation unit, the settlement processes for Commodity Participation Certificates, etc. can occur in systems 511 as shown in FIG. 31. Generation of creation units can be implemented using any technique. Also, data structures used to represent contents of the creation units and Commodity Participation Certificates can be stored in memory and in persistence storage. The Commodity Participation Certificates can be represented by certificates or preferably as book entries in the records of an administrator or broker/dealer or clearing house or transfer agent or registrar either as manual entries or preferably as data structures in an administrator or a broker/dealer's computer systems. Electronic messages such as messages distributed over a network are used to publicly disclose events pertaining to creation, redemption, trading and administration of commodity participation certificates.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files, such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

An example of one such type of computer is shown in FIG. 31, which shows a block diagram of a programmable processing system (system) 51 1 suitable for implementing or performing the apparatus or methods described herein. The system 511 includes a processor 520, a random access memory (RAM) 521, a program memory 522 (for example, a writeable read-only memory (ROM) such as a flash ROM), a hard drive controller 523, and an input/output (I/O) controller 524 coupled by a processor (CPU) bus 525. The system 511 can be preprogrammed, in ROM, for example, or it can be programmed (and reprogrammed) by loading a program from another source (for example, from a floppy disk, a CD-ROM, or another computer).

The hard drive controller 523 is coupled to a hard disk 130 suitable for storing executable computer programs, including programs embodying the present invention, and data including storage. The I/O controller 524 is coupled by an I/O bus 526 to an I/O interface 527. The I/O interface 527 receives and transmits data in analog or digital form over communication links such as a serial link, local area network, wireless link, and parallel link.

While embodiments have been described above in which a creation unit includes a long put commodity option position, in some embodiments, a long commodity futures option position can be substituted for the long put commodity option position in a creation unit.

While embodiments have been described above in which a creation unit includes a short put commodity option position, in some embodiments, a short put commodity futures option position can be substituted for the short put commodity option position in a creation unit.

While embodiments have been described above in which a creation unit includes a long call commodity option position, in some embodiments, a long call commodity futures option position can be substituted for the long call commodity option position in a creation unit.

While embodiments have been described above in which a creation unit includes a short call commodity option position, in some embodiments, a short call commodity futures option position can be substituted for the short call commodity option position in a creation unit.

Particular embodiments have been described; however other embodiments are within the scope of the following claims.

What is claimed is:

1. A computer implemented method, comprising:
determining in a computer system, a value for a tradable derivative share that tracks performance of a derivative contract that settles with physical delivery of an underlying physical commodity, the derivative contract share backed by a fractional interest in a creation unit that includes the derivative contract and an amount of cash that secures the tradable derivative share.

2. The computer implemented method of claim 1 wherein the derivative contract comprises a long position in a physically settled futures contract.

3. The computer implemented method of claim 2 wherein determining the value of the tradable derivative share comprises:
accessing in the computer system a representation of the creation unit that includes fields that identify the long physically settled futures contract and the defined amount of cash.

4. The computer implemented method of claim 3 wherein accessing in the computer system the representation of the creation unit comprises:
accessing an initial mark price of the physically settled futures contract size multiplier; and
accessing a current value for the defined amount of cash included in the creation unit.

5. The computer implemented method of claim 4, further comprising:
calculating in the computer, the current value for the defined amount of cash by multiplying the market price of the futures contract on a particular date by the futures contract size multiplier.

6. The computer implemented method of claim 2, wherein determining the value for the tradable derivative share further comprises:
modifying the initial value for the defined amount of cash based on performance of the long physically settled futures contract.

7. The computer implemented method of claim 1, wherein the tradable derivative share comprises a fixed-term tradable long physically settled futures contract and the method further comprises:
accessing a record that includes an expiration date of the long physically settled futures contract; and
accepting delivery of the underlying physical commodity of the long physically settled futures contract on the settlement date;
selling the physical commodity in a cash market for the underlying physical commodity; and
liquidating the tradable derivative shares by:
distributing cash to accounts of holders of the tradable derivative shares, the cash determined from the cash received from selling the physical commodity and any cash that was held on account.

8. The computer implemented method of claim 7, wherein liquidating the tradable derivative shares comprises:
multiplying the determined value for the tradable derivative shares by a number of tradable derivative shares held by a holder of the tradable derivative shares to generate a total value;
subtracting an administration fee from the total value to generate a liquidation value; and
distributing the liquidation value of cash to the account of the holder of the tradable derivative shares.

9. A computer implemented method comprising:
producing a creation unit by accepting delivery of a long physically settled futures contract and cash corresponding to the mark price of the long physically settled futures contract multiplied by a futures contract size multiplier; and
recording in the computer system a plurality of Commodity futures Participation Certificates representing a fractional interest in the creation unit.

10. The computer implemented method of claim 9, further comprising listing the Commodity futures Participation Certificates on a securities exchange.

11. The computer implemented method of claim 9 wherein producing the creation unit further comprises:
determining a number of Commodity futures Participation Certificates to issue based on a value of the long physically settled futures contracts.

12. The computer implemented method of claim 9 wherein the creation unit comprises a plurality of different long open physically settled futures contract positions.

13. The computer implemented method of claim 9, further comprising:
disseminating an electronic message to publicly disclose the long physically settled futures contract and a total value of the cash included in the creation unit.

14. The computer implemented method of claim 9, further comprising:
purchasing an interest bearing instrument with the cash; and
adding by the computer system interest from the interest bearing instrument to the cash.

15. A computer implemented method comprising:
determining a cash value to give to holders of Commodity futures Participation Certificates that represent an undivided interest in a creation unit of the Commodity futures Participation Certificates by:
recording acceptance of delivery of the physical commodity underlying a long physically settled, futures contract held as a portion of the creation unit along with cash;
recording of selling the physical commodity in a cash market for the physical commodity in exchange for cash received; and
accumulating in the computer the cash received from selling of the physical commodity underlying the long physically settled futures contract with any cash that was part the creation unit.

16. The computer implemented method of claim 9, further comprising recording distributing the accumulated cash in exchange for the Commodity futures Participation Certificate shares.

17. The computer implemented method of claim 15 wherein distributing the cash further comprises:
determining in the computer a value to provide on each of the Commodity futures Participation Certificates based on the total value of cash divided by the number of Commodity futures Participation Certificates outstanding.

18. The computer implemented method of claim 15 wherein distributing the cash further comprises:
determining in the computer a value to provide on each of the Commodity futures Participation Certificates based on the total value of cash minus administrative fees, and the result divided by the number of Commodity futures Participation Certificates outstanding.

19. A computer program product residing on a computer readable medium for administering tradable derivative shares comprises instructions for causing a computer system to:
determine a value for a tradable derivative share that tracks performance of a derivative contract that settles with physical delivery of an underlying physical commodity, the derivative contract share backed by a fractional interest in a creation unit that includes the derivative contract and an amount of cash that secures the tradable derivative share.

20. The computer program product of claim 19 wherein the derivative contract comprises a long position in a physically settled futures contract.

21. The computer program product of claim 19 wherein determining the value of the tradable derivative share comprises instructions to:
access a data representation stored in the computer system, of the creation unit that includes fields that identify the long physically settled futures contract and the defined amount of cash.

22. The computer program product of claim 19 wherein instructions to access the representation of the creation unit comprises instructions to:
access an initial mark price of the physically settled Futures Contract size multiplier; and
access a current value for the defined amount of cash included in the creation unit.

23. The computer program product of claim 22, further comprising instructions to:
calculate the current value for the defined amount of cash by multiplying the market price of the Futures Contract on a particular date by the futures contract size multiplier.

24. The computer program product of claim 20 wherein instructions to determine the value for the tradable derivative share further comprises instructions to:
modify the initial value for the defined amount of cash based on performance of the long physically settled futures contract.

25. The computer program product of claim 20, wherein the tradable derivative share comprise a fixed-term tradable long physically settled futures contract and the computer program product further comprises instructions to:
access a record that includes an expiration date of the long physically settled futures contract; and
indicate an acceptance of delivery of the underlying physical commodity of the physically settled futures contract on the settlement date when delivery is made;
indicate sale of the physical commodity in a cash market for the underlying physical commodity when the sale is made; and
liquidate the tradable derivative shares by distributing cash to holders of the tradable derivative shares, the cash determined from the cash received from selling the physical commodity and any cash that was held on account.

26. The computer program product of claim 25 wherein instructions to liquidate the tradable derivative shares comprise instructions to:
multiply the determined value for the tradable derivative shares by a number of tradable derivative shares held by a holder of the tradable derivative shares to generate a total value;
subtract an administration fee from the total value to generate a liquidation value; and
distribute the liquidation value of cash to the holder of the tradable derivative shares.

27. A computer program product residing on a computer readable medium for administering tradable derivative shares comprises instructions for causing a computer system to:
produce a data representation in a computer system, the data representation representing a creation unit for a tradable derivative share that tracks performance of a derivative contract that settles with physical delivery of an underlying physical commodity the data representation comprising fields that indicate:
acceptance of delivery of a long physically settled futures contract;
acceptance of delivery of cash corresponding to the mark price of the long physically settled futures contract multiplied by a futures contract size multiplier; and
store in the computer system, data representations corresponding to a plurality of shares representing a fractional interest in the creation unit.

28. The computer program product of claim 27, further comprising instructions to:
produce an indication that the shares are listed on a securities exchange.

29. The computer program product of claim 27 wherein instructions to produce the creation unit further comprise instructions to:
determine a number of shares to issue based on a value of the long physically settled futures contracts.

30. The computer program product of claim 27 wherein data representation of the creation unit comprises fields to track a plurality of different long open physically settled futures contract positions that comprise the creation unit.

31. The computer program product of claim 27, further comprising instructions:
disseminate the long physically settled futures contract and a total value of the cash included in the creation unit over an electronic network.

32. The computer program product of claim 27, further comprising instructions to:
record in a computer storage medium the purchase an interest bearing instrument with the cash; and
record in a computer storage medium the addition of interest from the interest bearing instrument to the value of cash stored in the creation unit representation.

33. A computer program product residing on a computer readable medium for administering tradable derivative shares comprises instructions for causing a computer system to:
determine a cash value to give to holders of Commodity futures Participation Certificates that represent an undivided interest in a creation unit of the Commodity futures Participation Certificates by instructions to:
record in a data representation of a creation unit corresponding to the Commodity futures Participation Certificates acceptance of delivery of physical commodity underlying a long physically settled, futures contract held as a portion of the creation unit along with cash;
record in the data representation of the creation unit, the sale of the physical commodity in a cash market for the physical commodity in exchange for cash received; and
record an accumulation of the cash received from selling of the physical commodity underlying the long physically settled futures contract with cash value that was part the creation unit.

34. The computer program product of claim 33, further comprising instructions to record a distribution of the accumulated cash in exchange for the Commodity futures Participation Certificate shares.

35. The computer program product of claim 33, wherein instructions to distribute the cash further comprise instructions to:
determine a value to provide on each of the Commodity futures Participation Certificates based on the total value of cash divided by the number of Commodity futures Participation Certificates outstanding.

36. The computer program product of claim 33 wherein instructions to distribute the cash further comprise instructions to:
determine a value to provide on each of the Commodity futures Participation Certificates based on the total value of cash minus administrative fees, and the result divided by the number of Commodity futures Participation Certificates outstanding.

37. A memory storing a data structure for use with an application program that is executed on a computer, the application program for administering tradable derivative shares, the data structure comprising:
a data representation of a creation unit, the data representation comprising fields that indicate:
a long physically settled futures contract;
cash corresponding to the mark price of the long physically settled futures contract;
a futures contract size multiplier; and
an entry corresponding to a number of Commodity futures Participation Certificate shares.

38. The memory of claim 37 wherein the data structure further comprises:
a field storing an indication that the Commodity futures Participation Certificate shares are listed on a securities exchange.

39. The memory of claim 37 wherein the data structure further comprises:
a field to record the purchase of an interest bearing instrument with the cash; and
a field to record the addition of interest from the interest bearing instrument to the value of cash stored in the creation unit representation.

40. The memory of claim 37 wherein the data structure further comprises:
fields to track a plurality of different long open physically settled Futures Contract positions that comprise the creation unit.
